(19) United States
(12) Patent Application Publication
(10) Pub. No.: US 2024/0068795 A1
(43) Pub. Date: Feb. 29, 2024

(54) SENSOR UNIT

(71) Applicant: Murata Manufacturing Co., Ltd., Kyoto (JP)

(72) Inventor: Koji KAWANO, Kyoto (JP)

(21) Appl. No.: 18/505,507

(22) Filed: Nov. 9, 2023

Related U.S. Application Data
(63) Continuation of application No. PCT/JP2022/010520, filed on Mar. 10, 2022.

(30) Foreign Application Priority Data
May 11, 2021 (JP) 2021-080402

(51) Int. Cl. G01B 7/16; G01L 1/16

(52) U.S. Cl. CPC G01B 7/16; G01L 1/16

(57) ABSTRACT

A sensor unit includes a first sensor portion that detects deformation of an object to be measured and has a film shape, a second sensor portion that detects deformation of the object to be measured and has a film shape, and a sheet to be attached to the object to be measured. A main surface of the first sensor portion and a main surface of the second sensor portion are attached to the sheet. In a state that the sheet is expanded in a plane, the main surface of the first sensor portion has a portion not overlapping the main surface of the second sensor portion, and the main surface of the second sensor portion has a portion not overlapping the main surface of the first sensor portion, in a view in a direction normal to the main surface of the sheet.

### CROSS REFERENCE TO RELATED APPLICATION

This is a continuation of International Application No. PCT/JP2022/010520 filed on Mar. 10, 2022 which claims priority from Japanese Patent Application No. 2021-080402 filed on May 11, 2021. The contents of these applications are incorporated herein by reference in their entireties.

### BACKGROUND OF THE DISCLOSURE

### Field of the Disclosure

The present disclosure relates to a sensor unit for detecting deformation of an object to be measured.

### Description of the Related Art

As a disclosure concerning a sensor unit in the related art, a swing analysis device, a swing analysis method, and a swing analysis system described in Patent Document 1 are known, for example. A swing analysis device described in Patent Document 1 includes an information input unit that receives acceleration information, angular velocity information, and distortion information of a golf club shaft detected by a sensor attached to the golf club shaft, a posture calculation unit that calculates posture information of the golf club in a swing period, based on the acceleration information and the angular velocity information, a correction unit that corrects the posture information of the golf club at the time of impact, based on the distortion information of the golf club shaft, and a display control unit that causes a display to display the posture information of the golf club corrected by the correction unit. With the use of the swing analysis device described above, swing of a golf club may be analyzed.
Patent Document 1: Japanese Patent No. 6342034

### BRIEF SUMMARY OF THE DISCLOSURE

In the swing analysis device described in Patent Document 1, there is a demand for improving positioning accuracy of the sensor.

A possible benefit of the present disclosure is to provide a sensor unit having high positioning accuracy of a plurality of sensor portions.

A sensor unit according to an embodiment of the present disclosure is a sensor unit for detecting deformation of an object to be measured. The sensor unit includes a first sensor portion configured to detect deformation of the object to be measured and having a film shape, a second sensor portion configured to detect deformation of the object to be measured and having a film shape, and a sheet attached to the object to be measured. A main surface of the first sensor portion and a main surface of the second sensor portion are attached to the sheet. In a state that the sheet is expanded in a plane, the main surface of the first sensor portion has a portion not overlapping the main surface of the second sensor portion in a view in a direction normal to the main surface of the sheet. In the state that the sheet is expanded in a plane, the main surface of the second sensor portion has a portion not overlapping the main surface of the first sensor portion in a view in the direction normal to the main surface of the sheet.

In the configuration above, in the state that the sheet is expanded in a plane, the first sensor portion having the film shape and the second sensor portion having the film shape are positioned on the sheet. Further, when the sheet is attached to the object to be measured, the sheet is positioned on the object to be measured. Thus, when the sensor unit is attached to the object to be measured having a three dimensional shape, neither positioning of the first sensor portion nor positioning of the second sensor portion is required. Therefore, the positioning of the first sensor portion and the positioning of the second sensor portion may easily and accurately be performed.

In the present description, an axis or a member extending in a first direction does not necessarily include only an axis or a member parallel to the first direction. The axis or the member extending in the first direction is an axis or a member inclined in a range of ±45 degrees relative to the first direction. Similarly, an axis or a member extending in a front-back direction is an axis or a member inclined in a range of ±45 degrees relative to the front-back direction. An axis or a member extending in a left-right direction is an axis or a member inclined in a range of ±45 degrees relative to the left-right direction. An axis or a member extending in an up-down direction is an axis or a member inclined in a range of ±45 degrees relative to the up-down direction.

In the present description, directions are defined as follows. In golf clubs 20 and 20a to 20f, respective shafts 21 and 21a to 21f being the object to be measured have a shape of a cylinder, and a center axis direction of the cylinder is defined as the first direction. A rotating direction about the first direction is defined as a circumferential direction. A direction orthogonal to the first direction is defined as a second direction. A direction orthogonal to the first direction and the second direction is defined as a third direction. In a state that sheets 11 and 11a to 11e and sensor units 10 and 10a to 10f are expanded in a plane, a direction normal to a main surface of each of the sheets 11 and 11a to 11e and the sensor units 10 and 10a to 10f is defined as a front-back direction. In the state that the sheet 11 and 11a to 11e and the sensor units 10 and 10a to 10f are expanded in a plane, a direction in which first sensor portions 12 and 12a to 12f and second sensor portions 13 and 13a to 13f are arranged side by side, respectively, is defined as a left-right direction in a view in the front-back direction. A direction orthogonal to the front-back direction and the left-right direction is defined as an up-down direction.

In the present description, unless otherwise specified, each portion of a first member is defined as follows. A front portion of the first member means a front half of the first member. A back portion of the first member means a back half of the first member. A left portion of the first member means a left half of the first member. A right portion of the first member means a right half of the first member. An upper portion of the first member means an upper half of the first member. A lower portion of the first member means a lower half of the first member.

According to the present disclosure, a sensor unit having high positioning accuracy may be obtained.

### BRIEF DESCRIPTION OF THE SEVERAL VIEWS OF THE DRAWINGS

FIG. 1 is a plan view of a sensor unit 10 in a state that a sheet 11 according to a first embodiment is expanded in a plane.

FIG. 2 is a plan view and a sectional view of a first sensor portion 12 in the state that the sheet 11 according to the first embodiment is expanded in a plane.

FIG. 3 is a plan view and a sectional view of a second sensor portion 13 in the state that the sheet 11 according to the first embodiment is expanded in a plane.

FIG. 4 is a perspective view of the sensor unit 10 according to the first embodiment in a state of being attached to a shaft 21.

FIG. 5 is a sectional view of the sensor unit 10 according to the first embodiment in the state of being attached to the shaft 21 taken along a line A-A.

FIG. 6 is a perspective view of a sensor unit 10a according to a first modification in a state of being attached to a shaft 21a.

FIG. 7 is a sectional view of the sensor unit 10a according to the first modification in the state of being attached to the shaft 21a taken along a line A-A.

FIG. 8 is a plan view of a sensor unit 10b in a state that a sheet 11b according to a second embodiment is expanded in a plane.

FIG. 9 is a perspective view of the sensor unit 10b according to the second embodiment in a state of being attached to a shaft 21b.

FIG. 10 is a sectional view of the sensor unit 10b according to the second embodiment in the state of being attached to the shaft 21b taken along a line A-A.

FIG. 11 is a plan view of a sensor unit 10c in a state that a sheet 11c according to a third embodiment is expanded in a plane.

FIG. 12 is a perspective view of the sensor unit 10c according to the third embodiment in a state of being attached to a shaft 21c.

FIG. 13 is a sectional view of the sensor unit 10c according to the third embodiment in the state of being attached to the shaft 21c taken along a line A-A.

FIG. 14 is a plan view of a sensor unit 10d in a state that a sheet 11d according to a fourth embodiment is expanded in a plane.

FIG. 15 is a perspective view of the sensor unit 10d according to the fourth embodiment in a state of being attached to a shaft 21d.

FIG. 16 is a sectional view of the sensor unit 10d according to the fourth embodiment in the state of being attached to the shaft 21d taken along a line A-A.

FIG. 17 is a plan view of a sensor unit 10e in a state that a sheet 11e according to a fifth embodiment is expanded in a plane.

FIG. 18 is a perspective view of the sensor unit 10e according to the fifth embodiment in a state of being attached to a shaft 21e.

FIG. 19 is a sectional view of the sensor unit 10e according to the fifth embodiment in the state of being attached to the shaft 21e taken along a line A-A.

FIG. 20 is a plan view of a sensor unit 10f in a state that the sensor unit 10f according to a sixth embodiment is expanded in a plane.

FIG. 21 is a plan view and a sectional view of a third sensor portion 14f in the state that the sensor unit 10f according to the sixth embodiment is expanded in a plane.

FIG. 22 is a plan view and a sectional view of a fourth sensor portion 15f in the state that the sensor unit 10f according to the sixth embodiment is expanded in a plane.

FIG. 23 is a perspective view of the sensor unit 10f according to the sixth embodiment in a state of being attached to a shaft 21f.

FIG. 24 is a sectional view of the sensor unit 10f according to the sixth embodiment in the state of being attached to the shaft 21f taken along a line A-A.

### DETAILED DESCRIPTION OF THE DISCLOSURE

### First Embodiment

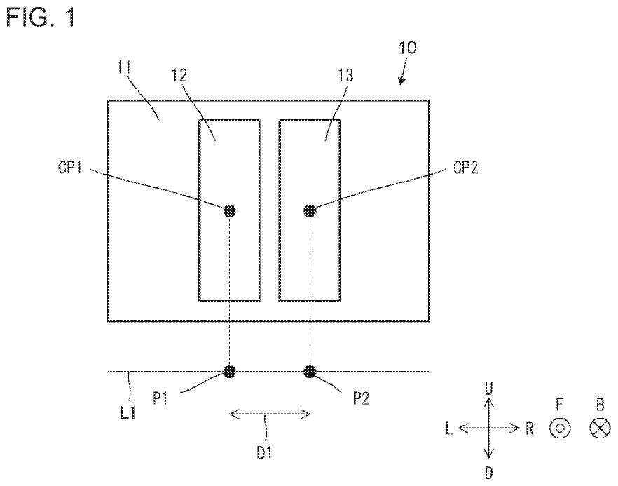

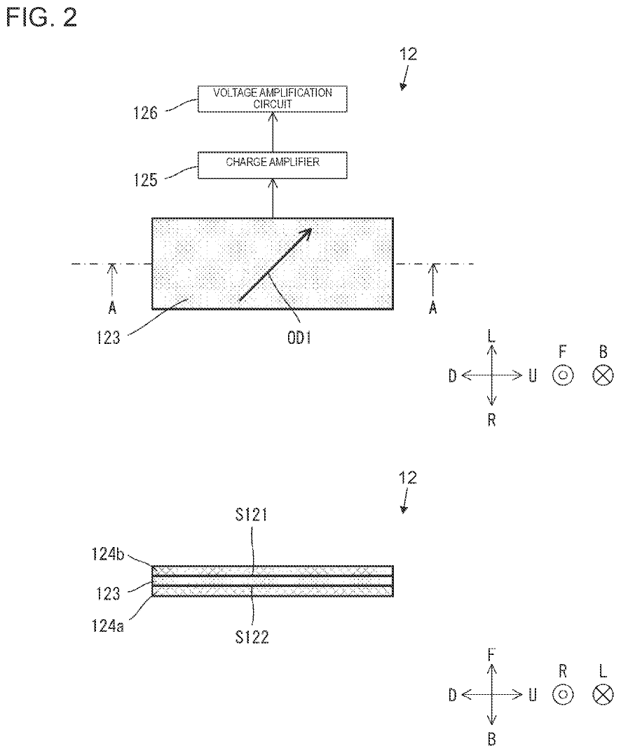

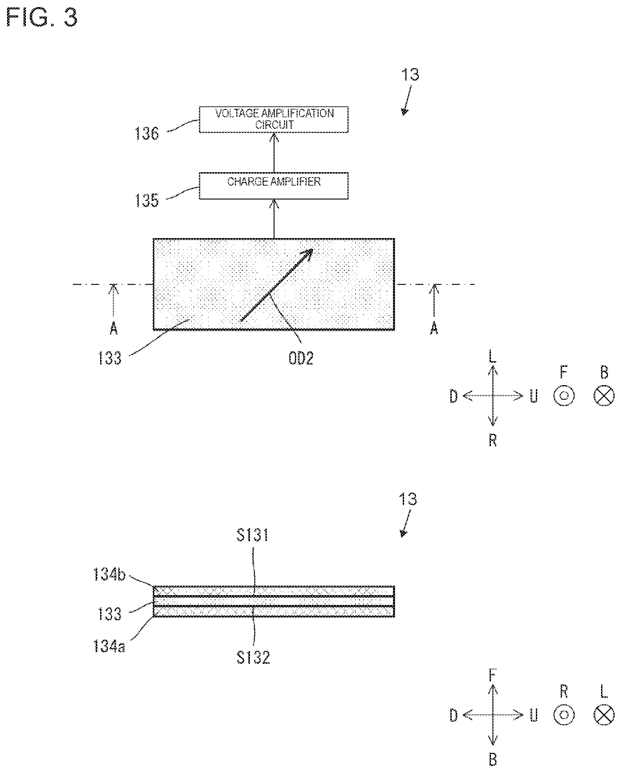

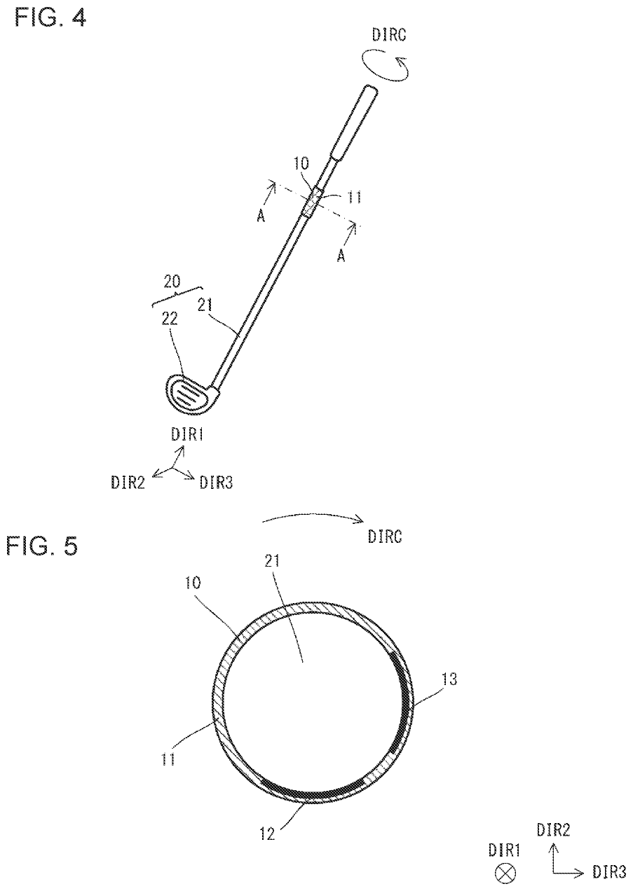

Hereinafter, a sensor unit according to a first embodiment of the present disclosure will be described with reference to the accompanying drawings. FIG. 1 is a plan view of a sensor unit 10 in a state that a sheet 11 according to the first embodiment is expanded in a plane. FIG. 2 is a plan view and a sectional view of a first sensor portion 12 in the state that the sheet 11 according to the first embodiment is expanded in a plane. FIG. 3 is a plan view and a sectional view of a second sensor portion 13 in the state that the sheet 11 according to the first embodiment is expanded in a plane. FIG. 4 is a perspective view of the sensor unit 10 according to the first embodiment in a state of being attached to a shaft 21. FIG. 5 is a sectional view of the sensor unit 10 according to the first embodiment in the state of being attached to the shaft 21 taken along a line A-A.

The sensor unit 10 is a sensor unit that detects deformation of the shaft 21 described later. As illustrated in FIG. 1, the sensor unit 10 includes the sheet 11, the first sensor portion 12, and the second sensor portion 13. The sheet 11 is a sheet to be attached to the shaft 21 described later. The sheet 11 has a front main surface and a back main surface. The front main surface and the back main surface of the sheet 11 each have a rectangular shape. A front main surface of the sheet 11 has a rectangular shape having a left short side and a right short side that are extending in the up-down direction, and an upper long side and a lower long side that are extending in the left-right direction. The back main surface of the sheet 11 has a left short side and a right short side that are extending in the up-down direction, and an upper long and a lower long side that are extending in the left-right direction. In the state that the sheet 11 is expanded in a plane, a length of each of the upper long side and the lower long side of the front main surface of the sheet 11, and a length of each of the upper long side and the lower long side of the back main surface of the sheet 11 each are equal to or greater than a circumferential length of a sectional circle of the shaft 21 described later. An adhesive layer (not illustrated) is provided on the front main surface of the sheet 11. The adhesive layer has an insulation property.

The first sensor portion 12 detects deformation of the shaft 21 described later, and has a film shape. The first sensor portion 12 has a front main surface and a back main surface. As illustrated in FIG. 2, the first sensor portion 12 includes a piezoelectric film 123, a first electrode 124a, a second electrode 124b, a charge amplifier 125, and a voltage amplification circuit 126. The piezoelectric film 123 is an example of a piezoelectric body. The piezoelectric film 123 has a sheet shape. The piezoelectric film 123 (first piezoelectric body) has a front main surface S121 and a back main surface S122. In the state that the sheet 11 is expanded in a plane, the front main surface S121 and the back main surface S122 of the piezoelectric film 123 (first piezoelectric body) each have a rectangular shape having long sides extending in the up-down direction and short sides extending in the left-right direction in a view in the front-back direction. In the present embodiment, a longitudinal direction of the piezoelectric film 123 (first piezoelectric body) of the first sensor portion 12 is the up-down direction, and a lateral direction of the piezoelectric film 123 (first piezoelectric body) of the first sensor portion 12 is the left-right direction. In the present embodiment, the piezoelectric film 123 is a PLA film.

The second sensor portion 13 detects deformation of the shaft 21 described later, and has a film shape. Note that, a deformation direction detected by the first sensor portion 12 and a deformation direction detected by the second sensor portion 13, of the shaft 21 described later, are different from each other. The second sensor portion 13 has a front main surface and a back main surface. As illustrated in FIG. 3, the second sensor portion 13 includes a piezoelectric film 133, a first electrode 134a, a second electrode 134b, a charge amplifier 135, and a voltage amplification circuit 136. The piezoelectric film 133 is an example of a piezoelectric body. The piezoelectric film 133 has a sheet shape. The piezoelectric film 133 (second piezoelectric body) has a front main surface S131 and a back main surface S132. In the state that the sheet 11 is expanded in a plane, the front main surface S131 and the back main surface S132 of the piezoelectric film 133 (second piezoelectric body) each have a rectangular shape having long sides extending in the up-down direction and short sides extending in the left-right direction in a view in the front-back direction. In the present embodiment, a longitudinal direction of the piezoelectric film 133 (second piezoelectric body) of the second sensor portion 13 is the up-down direction, and a lateral direction of the piezoelectric film 133 (second piezoelectric body) of the second sensor portion 13 is the left-right direction. In the present embodiment, the piezoelectric film 133 is a PLA film. Hereinafter, the piezoelectric film 123 and the piezoelectric film 133 will be described in more detail.

Each of the piezoelectric film 123 and the piezoelectric film 133 generates electric charge corresponding to a differential value of deformation amount of each of the piezoelectric film 123 and the piezoelectric film 133. Each of the piezoelectric film 123 and the piezoelectric film 133 has a characteristic in which polarity of electric charge generated at a time being extended in the up-down direction is opposite to polarity of electric charge generated at a time being extended in the left-right direction. Specifically, each of the piezoelectric film 123 and the piezoelectric film 133 is a film formed of a chiral polymer. The chiral polymer is polylactic acid (PLA), particularly L-type polylactic acid (PLLA), for example. PLLA composed of a chiral polymer has a main chain having a helical structure. PLLA has a piezoelectric property in which molecules are oriented by being uniaxially extended. Each of the piezoelectric film 123 and the piezoelectric film 133 has a d14 piezoelectric constant. A uniaxial extension axis OD1 of the piezoelectric film 123 (first piezoelectric body) forms an angle of 45 degrees counterclockwise relative to the up-down direction, and a uniaxial extension axis OD2 of the piezoelectric film 133 (second piezoelectric body) forms an angle of −45 degrees counterclockwise relative to the left-right direction. That is, each of the piezoelectric film 123 (first piezoelectric body) and the piezoelectric film 133 (second piezoelectric body) is extended in at least one axial direction. The angle of −45 degrees includes an angle of −45 degrees plus or minus approximately 10 degrees, for example. With this, each of the piezoelectric film 123 and the piezoelectric film 133 generates electric charge when deformed to be extended or to be compressed in the up-down direction. Each of the piezoelectric film 123 and the piezoelectric film 133 generates positive electric charge when deformed to be extended in the up-down direction, for example. Each of the piezoelectric film 123 and the piezoelectric film 133 generates negative electric charge when deformed to be compressed in the up-down direction, for example. Magnitude of the electric charge depends on a differential value of deformation amount of each of the piezoelectric film 123 and the piezoelectric film 133 caused by extension or compression.

The first electrode 124a is a signal electrode. As illustrated in FIG. 2, the first electrode 124a is provided on the back main surface S122. The first electrode 124a covers the back main surface S122. The first electrode 124a is an organic electrode such as indium tin oxide (ITO) or zinc oxide (ZnO), a metal coat formed by vapor deposition or plating, or a printed electrode film formed by silver paste, for example.

The second electrode 124b is a ground electrode. The second electrode 124b is coupled to a ground electric potential. As illustrated in FIG. 2, the second electrode 124b is provided on the front main surface S121. Thus, the piezoelectric film 123 is positioned between the first electrode 124a and the second electrode 124b. The second electrode 124b covers the front main surface S121. The second electrode 124b is an organic electrode such as indium tin oxide (ITO) and zinc oxide (ZnO), a metal coat formed by vapor deposition or plating, or a printed electrode film formed by silver paste, for example.

The charge amplifier 125 converts electric charge generated by the piezoelectric film 123 into a detection signal, being a voltage signal, and outputs the detection signal to the voltage amplification circuit 126. The voltage amplification circuit 126 amplifies and outputs the detection signal.

The first sensor portion 12 described above is attached to the sheet 11 via an adhesive layer (not illustrated). In more detail, the adhesive layer has an insulation property. Specifically, the adhesive layer fixes the first electrode 124a and the front main surface of the sheet 11. That is, a back main surface of the first sensor portion 12 is fixed to the front main surface of the sheet 11.

The first electrode 134a is a signal electrode. As illustrated in FIG. 3, the first electrode 134a is provided on the back main surface S132. The first electrode 134a covers the back main surface S132. The first electrode 134a is an organic electrode such as indium tin oxide (ITO) and zinc oxide (ZnO), a metal coat formed by vapor deposition or plating, or a printed electrode film formed by silver paste, for example.

The second electrode 134b is a ground electrode. The second electrode 134b is coupled to the ground electric potential. As illustrated in FIG. 3, the second electrode 134b is provided on the front main surface S131. Thus, the piezoelectric film 133 is positioned between the first electrode 134a and the second electrode 134b. The second electrode 134b covers the front main surface S131. The second electrode 134b is an organic electrode such as indium tin oxide (ITO) and zinc oxide (ZnO), a metal coat formed by vapor deposition or plating, or a printed electrode film formed by silver paste, for example.

The charge amplifier 135 converts electric charge generated by the piezoelectric film 133 into a detection signal, being a voltage signal, and outputs the detection signal to the voltage amplification circuit 136. The voltage amplification circuit 136 amplifies and outputs the detection signal.

The second sensor portion 13 described above is attached to the sheet 11 via an adhesive layer (not illustrated). In more detail, the adhesive layer has an insulation property. Specifically, the adhesive layer fixes the first electrode 134a and the front main surface of the sheet 11. That is, a back main surface of the second sensor portion 13 is fixed to the front main surface of the sheet 11.

As illustrated in FIG. 1, in the state that the sheet 11 is expanded in a plane, a front main surface of the first sensor portion 12 is disposed at a position not overlapping a front main surface of the second sensor portion 13 in a view in the front-back direction. That is, in the state that the sheet 11 is expanded in a plane, the front main surface of the first sensor portion 12 has a portion not overlapping the front main surface of the second sensor portion 13 in a view in the front-back direction. The second sensor portion 13 is positioned to the right of the first sensor portion 12. In the state that the sheet 11 is expanded in a plane, the front main surface of the second sensor portion 13 is disposed at a position not overlapping the front main surface of the first sensor portion 12 in a view in the front-back direction. That is, in the state that the sheet 11 is expanded in a plane, the front main surface of the second sensor portion 13 has a portion not overlapping the front main surface of the first sensor portion 12 in a view in the front-back direction.

As illustrated in FIG. 1, in the state that the sheet 11 is expanded in a plane, the left short side and the right short side of the front main surface of the sheet 11, each of long sides of the first sensor portion 12, and each of long sides of the second sensor portion 13 are parallel to each other. Further, in the state that the sheet 11 is expanded in a plane, the upper long side and the lower long side of the front main surface of the sheet 11, each of short sides of the first sensor portion 12, and each of short sides of the second sensor portion 13 are parallel to each other.

As illustrated in FIG. 1, in the state that the sheet 11 is expanded in a plane, a first center point CP1 of the first sensor portion 12 is defined in a view in the front-back direction. The first center point CP1 is a center of gravity of the front main surface of the first sensor portion 12, for example. The first center point CP1 may be a center of gravity of the back main surface of the first sensor portion 12, for example. The first center point CP1 may be a center of the front main surface of the first sensor portion 12, for example. At this time, when two diagonal lines are defined on the front main surface of the first sensor portion 12, for example, the two diagonal lines intersect with each other at the first center point CP1. When a straight line connecting midpoints of the two short sides and a straight line connecting midpoints of the two long sides are defined on the front main surface of the first sensor portion 12, for example, the straight line connecting the midpoints of the two short sides and the straight line connecting the midpoints of the two long sides intersect with each other at the first center point CP1. The first center point CP1 may be a center of the back main surface of the first sensor portion 12, for example. At this time, when two diagonal lines are defined on the back main surface of the first sensor portion 12, for example, the two diagonal lines intersect with each other at the first center point CP1. When a straight line connecting midpoints of the two short sides and a straight line connecting midpoints of the two long sides are defined on the back main surface of the first sensor portion 12, for example, the straight line connecting the midpoints of the two short sides and the straight line connecting the midpoints of the two long sides intersect with each other at the first center point CP1.

Similarly, in the state that the sheet 11 is expanded in a plane, a second center point CP2 of the second sensor portion 13 is defined in a view in the front-back direction. The second center point CP2 is a center of gravity of the front main surface of the second sensor portion 13, for example. The second center point CP2 may be a center of gravity of the back main surface of the second sensor portion 13, for example. The second center point CP2 may be a center of the front main surface of the second sensor portion 13, for example. At this time, when two diagonal lines are defined on the front main surface of the second sensor portion 13, for example, the two diagonal lines intersect with each other at the second center point CP2. When a straight line connecting midpoints of the two short sides and a straight line connecting midpoints of the two long sides are defined on the front main surface of the second sensor portion 13, for example, the straight line connecting the midpoints of the two short sides and the straight line connecting the midpoints of the two long sides intersect with each other at the second center point CP2. The second center point CP2 may be a center of the back main surface of the second sensor portion 13, for example. At this time, when two diagonal lines are defined on the back main surface of the second sensor portion 13, for example, the two diagonal lines intersect with each other at the second center point CP2. When a straight line connecting midpoints of the two short sides and a straight line connecting midpoints of the two long sides are defined on the back main surface of the second sensor portion 13, for example, the straight line connecting the midpoints of the two short sides and the straight line connecting the midpoints of the two long sides intersect with each other at the second center point CP2.

As illustrated in FIG. 1, in the state that the sheet 11 is expanded in a plane, there is defined any straight line Li extending in the left-right direction in a view in the front-back direction. In the state that the sheet 11 is expanded in a plane, an intersection point of the straight line Li and a perpendicular line drawn from the first center point CP1 to the straight line Li, in a view in the front-back direction, is defined as a first intersection point P1. Further, an intersection point of the straight line Li and a perpendicular line drawn from the second center point CP2 to the straight line Li, in a view in the front-back direction, is defined as a second intersection point P2. A distance between the first intersection point P1 and the second intersection point P2 is defined as a first distance D1. In the state that the sheet 11 is expanded in a plane, the first distance D1 of the present embodiment is equal to one-fourth of a circumferential length of the sectional circle of the shaft 21 described later.

As illustrated in FIG. 4, a golf club 20 has the shaft 21 and a head 22. The shaft 21 has a shape of a cylinder. A center axis direction of the cylinder is the same direction as a first direction DIR1. That is, the shaft 21 extends in the first direction DIR1. A section of the shaft 21 perpendicular to the first direction DIR1 has a shape of a circle. The circumferential direction of the sectional circle of the shaft 21 is the same direction as a circumferential direction DIRC. The shaft 21 has a first end and a second end in the first direction DIR1. The head 22 is provided at the first end of the shaft 21. A grip is provided near the second end of the shaft 21. In the present embodiment, an object to be measured is the shaft 21.

The sensor unit 10 is attached to the circumferential surface of the shaft 21. Specifically, the front main surface of the sheet 11 is fixed to the shaft 21 by an adhesive layer (not illustrated) provided on the front main surface of the sheet 11. The first sensor portion 12 is fixed to the shaft 21 by an adhesive layer (not illustrated) provided on the front main surface of the first sensor portion 12. The second sensor portion 13 is fixed to the shaft 21 by an adhesive layer (not illustrated) provided on the front main surface of the second sensor portion 13. In the example of FIG. 4, the sensor unit 10 is attached near the grip of the shaft 21, but an attachment position of the sensor unit 10 to the shaft 21 is not limited thereto. In a state that the sensor unit 10 is attached to the shaft 21, the upper long side and the lower long side of the front main surface of the sheet 11 each extend in the same direction as the circumferential direction DIRC.

As illustrated in FIG. 5, in the state that the sensor unit 10 is attached to the shaft 21, the first sensor portion 12 and the second sensor portion 13 are disposed between the shaft 21 and the sheet 11. The first sensor portion 12 detects deformation of the shaft 21 in a second direction DIR2. The second sensor portion 13 detects deformation of the shaft 21 in a third direction DIR3. As described above, the upper long side and the lower long side of the front main surface of the sheet 11 each extend in the same direction as the circumferential direction DIRC. Thus, the first distance D1 is equal to a distance between the first center point CP1 of the first sensor portion 12 and the second center point CP2 of the second sensor portion 13 in the circumferential direction DIRC. Further, as described above, in the state that the sheet 11 is expanded in a plane, the first distance D1 is equal to one-fourth of the circumferential length of the sectional circle of the shaft 21. Thus, the first center point CP1 of the first sensor portion 12 and the second center point CP2 of the second sensor portion 13 are disposed to be separated from each other by 90 degrees in the circumferential direction DIRC of the shaft 21.

### Effects

With the use of the sensor unit 10, the first sensor portion 12 and the second sensor portion 13 may accurately be positioned. In particular, it is suitable for a case that the first sensor portion 12 and the second sensor portion 13 are attached to a curved surface of an object to be measured. In more detail, in the state that the sheet 11 is expanded in a plane, the front main surface of the first sensor portion 12 has a portion not overlapping the front main surface of the second sensor portion 13 in a view in a direction normal to the front main surface of the sheet 11. Further, in the state that the sheet 11 is expanded in a plane, the front main surface of the first sensor portion 12 is disposed at a position not overlapping the front main surface of the second sensor portion 13 in a view in the direction normal to the front main surface of the sheet 11. In the state that the sheet 11 is expanded in a plane, the front main surface of the second sensor portion 13 has a portion not overlapping the front main surface of the first sensor portion 12 in a view in the direction normal to the front main surface of the sheet 11. Further, in the state that the sheet 11 is expanded in a plane, the front main surface of the second sensor portion 13 is disposed at a position not overlapping the front main surface of the first sensor portion 12 in a view in the direction normal to the front main surface of the sheet 11. In the sensor unit 10 described above, a position of the first sensor portion 12 and a position of the second sensor portion 13 are different from each other. Thus, it is necessary to position the first sensor portion 12 on the shaft 21, and to position the second sensor portion 13 on the shaft 21 as well. Meanwhile, in the sensor unit 10, the back main surface of the first sensor portion 12 and the back main surface of the second sensor portion 13 each are attached to the sheet 11. With this, in the state that the sheet 11 is expanded in a plane, the first sensor portion 12 and the second sensor portion 13 each may be positioned on the sheet 11. Accordingly, positioning the sheet 11 on the shaft 21 makes it possible to position the first sensor portion 12 and the second sensor portion 13 on the shaft 21 at the same time. Thus, the first sensor portion 12 and the second sensor portion 13 may accurately be positioned.

With the use of the sensor unit 10, in the state that the sheet 11 is expanded in a plane, the long side of the main surface of the first sensor portion 12 is parallel to the long side of the main surface of the second sensor portion 13. As a result, the first sensor portion 12 and the second sensor portion 13 may accurately be positioned.

Note that the sheet 11 may have an insulation property or may have electric conductivity.

In the state that the sheet 11 is expanded in a plane, each of the uniaxial extension axis OD1 of the piezoelectric film 123 (first piezoelectric body) and the uniaxial extension axis OD2 of the piezoelectric film 133 (second piezoelectric body) is not limited to have an angle of 45 degrees counterclockwise relative to the up-down direction, and may have another angle.

For example, in the state that the sheet 11 is expanded in a plane, each of the uniaxial extension axis OD1 of the piezoelectric film 123 (first piezoelectric body) and the uniaxial extension axis OD2 of the piezoelectric film 133 (second piezoelectric body) may form an angle of 45 degrees clockwise relative to the up-down direction. Note that the angle of 45 degrees includes an angle of 45 degrees plus or minus approximately 10 degrees, for example. In the configuration above, the piezoelectric film 123 generates positive electric charge when the first sensor portion 12 is deformed to be extended in the left-right direction, and generates negative electric charge when the first sensor portion 12 is deformed to be compressed in the left-right direction. The piezoelectric film 133 generates positive electric charge when the second sensor portion 13 is deformed to be extended in the left-right direction, and generates negative electric charge when the second sensor portion 13 is deformed to be compressed in the left-right direction.

For example, in the state that the sheet 11 is expanded in a plane, each of the uniaxial extension axis OD1 of the piezoelectric film 123 (first piezoelectric body) and the uniaxial extension axis OD2 of the piezoelectric film 133 (second piezoelectric body) may form an angle of 0 degrees counterclockwise or 180 degrees counterclockwise relative to the up-down direction. Note that the angle of 0 degrees or the angle of 180 degrees includes an angle of 0 degrees plus or minus approximately 10 degrees or an angle of 180 degrees plus or minus approximately 10 degrees, for example. In the configuration above, it is possible to make a direction, in which the piezoelectric property of the piezoelectric film 123 (first piezoelectric body) is the highest, coincide with a direction of torsion relative to the up-down direction and the left-right direction. Further, it is possible to make a direction, in which the piezoelectric property of the piezoelectric film 133 (second piezoelectric body) is the highest, coincide with a direction of torsion relative to the up-down direction and the left-right direction.

For example, in the state that the sheet 11 is expanded in a plane, each of the uniaxial extension axis OD1 of the piezoelectric film 123 (first piezoelectric body) and the uniaxial extension axis OD2 of the piezoelectric film 133 (second piezoelectric body) may form an angle of 90 degrees counterclockwise or −90 degrees counterclockwise relative to the up-down direction. Note that the angle of 90 degrees or the angle of −90 degrees includes an angle of 90 degrees plus or minus approximately 10 degrees or an angle of −90 degrees plus or minus approximately 10 degrees, for example. In the configuration above, it is possible to make a direction, in which the piezoelectric property of the piezoelectric film 123 (first piezoelectric body) is the highest, coincide with a direction of torsion relative to the up-down direction and the left-right direction. Further, it is possible to make a direction, in which the piezoelectric property of the piezoelectric film 133 (second piezoelectric body) is the highest, coincide with a direction of torsion relative to the up-down direction and the left-right direction.

In the present embodiment, in the sensor unit 10, each of the first sensor portion 12 and the second sensor portion 13 includes a film having PLA and extended in at least one axial direction. From a viewpoint of detecting deformation of an object to be measured, however, each of the first sensor portion 12 and the second sensor portion 13 may include a material having another piezoelectric body. Each of the first sensor portion 12 and the second sensor portion 13 may include a material having no piezoelectric property.

For example, each of the first sensor portion 12 and the second sensor portion 13 may have a d31 piezoelectric constant. Each of the first sensor portion 12 and the second sensor portion 13 having the d31 piezoelectric constant is a polyvinylidene fluoride (PVDF) film, for example.

The deformation detection of an object to be measured may be the detection of deformation amount itself.

For example, each of the first sensor portion 12 and the second sensor portion 13 may include a strain gauge.

The deformation detection of an object to be measured may be flexure detection of an object to be measured or torsion detection of an object to be measured.

The first electrode 124a may be provided on the front main surface S121. The second electrode 124b may be provided on the back main surface S122. The first electrode 134a may be provided on the front main surface S131. The second electrode 134b may be provided on the back main surface S132.

In the state that the sheet 11 is expanded in a plane, each of the front main surface and the back main surface of the first sensor portion 12 may have a rectangular shape having short sides extending in the up-down direction and long sides extending in the left-right direction in a view in the front-back direction. In the state that the sheet 11 is expanded in a plane, each of the front main surface and the back main surface of the second sensor portion 13 may have a rectangular shape having short sides extending in the up-down direction and long sides extending in the left-right direction in a view in the front-back direction.

Note that, in the state that the sheet 11 is expanded in a plane, the length of each of the upper long side and the lower long side of the front main surface of the sheet 11, and the length of each of the upper long side and the lower long side of the back main surface of the sheet 11 each may be longer than the circumferential length of the sectional circle of the shaft 21. In the state that the sensor unit 10 is attached to the shaft 21, the number of intersections of any straight line orthogonal to the first direction DIR1 and the front main surface of the sheet 11 may be three or more in a view in the first direction DIR1.

Note that, in the state that the sheet 11 is expanded in a plane, the length of each of the upper long side and the lower long side of the front main surface of the sheet 11, and the length of each of the upper long side and the lower long side of the back main surface of the sheet 11 each may be equal to the circumferential length of the sectional circle of the shaft 21.

Note that each of the front main surface and the back main surface of the sheet 11 need not have a rectangular shape. The rectangular shape includes a rectangle and a slightly deformed rectangle shape. The slightly deformed rectangle shape is a rectangle shape having rounded corners, for example. The shape of the front main surface and the back main surface of the sheet 11 may be a shape completely different from a rectangular shape.

The sheet 11 may have a uniform or non-uniform thickness (distance between the front main surface and the back main surface of the sheet 11).

In the state that the sheet 11 is expanded in a plane, the first distance D1 need not be equal to one-fourth of the circumferential length of the sectional circle of the shaft 21. For example, in the state that the sheet 11 is expanded in a plane, in a case that the first distance D1 is equal to one-sixth of the circumferential length of the sectional circle of the shaft 21, the first center point CP1 of the first sensor portion 12 and the second center point CP2 of the second sensor portion 13 are disposed to be separated from each other by 60 degrees in the circumferential direction DIRC of the shaft 21 in the state that the sensor unit 10 is attached to the shaft 21.

In the state that the sheet 11 is expanded in a plane, each of the front main surface and the back main surface of the first sensor portion 12 need not have a rectangular shape. Further, in the state that the sheet 11 is expanded in a plane, each of the front main surface and the back main surface of the second sensor portion 13 need not have a rectangular shape.

For example, in the state that the sheet 11 is expanded in a plane, each of the front main surface and the back main surface of the first sensor portion 12 may have an elliptical shape. In the case above, in the state that the sheet 11 is expanded in a plane, a long axis of the main surface of the first sensor portion 12 may be parallel to the long side of the main surface of the second sensor portion 13. Further, in the state that the sheet 11 is expanded in a plane, each of the front main surface and the back main surface of the first sensor portion 12, and each of the front main surface and the back main surface of the second sensor portion 13 each may have an elliptical shape. In the case above, in the state that the sheet 11 is expanded in a plane, a long axis of the main surface of the first sensor portion 12 may be parallel to a long axis of the main surface of the second sensor portion 13.

For example, in the state that the sheet 11 is expanded in a plane, the front main surface and the back main surface of the first sensor portion 12 may have a square shape. In the case above, in the state that the sheet 11 is expanded in a plane, at least one of the sides of the main surface of the first sensor portion 12 may be parallel to the long side of the main surface of the second sensor portion 13. Further, in the state that the sheet 11 is expanded in a plane, each of the front main surface and the back main surface of the first sensor portion 12, and each of the front main surface and the back main surface of the second sensor portion 13 each may have a square shape. In the case above, at least one of the sides of the main surface of the first sensor portion 12 may be parallel to at least one of the sides of the main surface of the second sensor portion 13.

In the state that the sheet 11 is expanded in a plane, a position of the first center point CP1 of the first sensor portion 12 and a position of the second center point CP2 of the second sensor portion 13 may be different from each other in the up-down direction.

In the state that the sheet 11 is expanded in a plane, the first sensor portion 12 and the second sensor portion 13 may be arranged side by side in the up-down direction.

In the state that the sheet 11 is expanded in a plane, the back main surface of the first sensor portion 12 may have a portion not overlapping the back main surface of the second sensor portion 13 in a view in the front-back direction.

A section of an object to be measured perpendicular to the first direction DIR1 is not limited to a circle. The section of the object to be measured perpendicular to the first direction DIR1 may be an ellipse or a polygon, for example.

The object to be measured may have a shape not extending in the first direction DIR1.

The number of sensor portions may be three or more.

(First Modification)

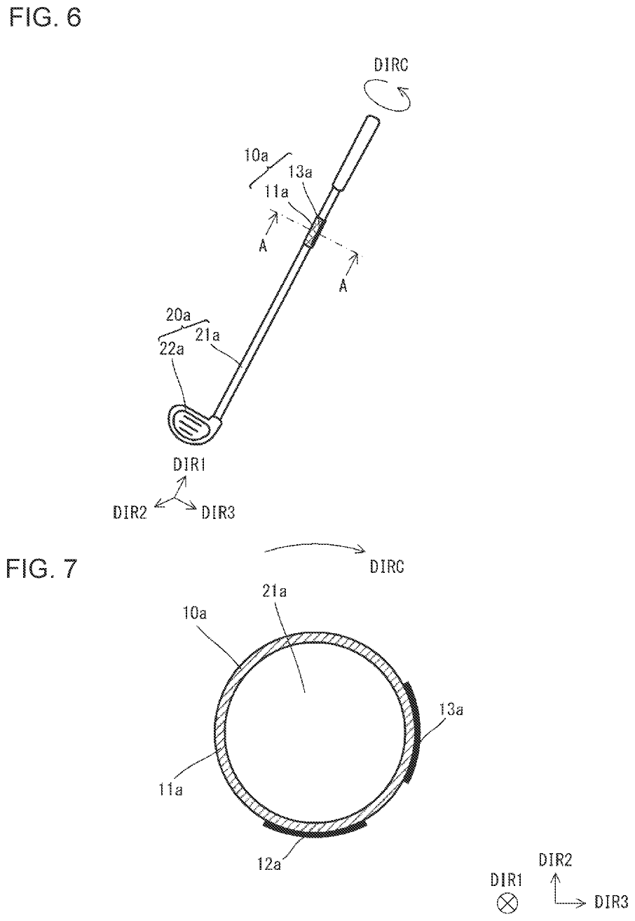

Hereinafter, a sensor unit 10a according to a first modification will be described with reference to the accompanying drawings. FIG. 6 is a perspective view of the sensor unit 10a according to the first modification in a state of being attached to a shaft 21a. FIG. 7 is a sectional view of the sensor unit 10a according to the first modification in the state of being attached to the shaft 21a taken along a line A-A. In the first modification, only portions different from the arrangement structure of the sensor unit according to the first embodiment will be described, and other descriptions will be omitted.

The sensor unit 10a differs from the sensor unit 10 in a state of attaching to the shaft 21a. In more detail, in a state that the sensor unit 10a is attached to the shaft 21a, a sheet 11a is disposed between the shaft 21a and a first sensor portion 12a, and between the shaft 21a and a second sensor portion 13a.

As illustrated in FIG. 6, the sensor unit 10a is attached to a circumferential surface of the shaft 21a. Specifically, an adhesive layer (not illustrated) is provided on a back main surface of the sheet 11a. The adhesive layer has an insulation property. The back main surface of the sheet 11a is attached to the shaft 21a by an adhesive layer (not illustrated) provided on the back main surface of the sheet 11a. In a state that sensor unit 10a is attached to the shaft 21a, an extending direction of each of an upper long side and a lower long side of a front main surface of the sheet 11a is the same direction as the circumferential direction DIRC.

As illustrated in FIG. 7, in the state that the sensor unit 10a is attached to the shaft 21a, the sheet 11a is disposed between the shaft 21a and the first sensor portion 12a, and between the shaft 21a and the second sensor portion 13a. As described above, each of the upper long side and the lower long side of the front main surface of the sheet 11a extends in the same direction as the circumferential direction DIRC. Thus, a first distance D1a is equal to a distance in the circumferential direction DIRC between a first center point CP1a of the first sensor portion 12a and a second center point CP2a of the second sensor portion 13a. Further, as described above, in a state that the sheet 11a is expanded in a plane, the first distance D1a is equal to one-fourth of a circumferential length of a sectional circle of the shaft 21a. Thus, the first center point CP1a of the first sensor portion 12a and the second center point CP2a of the second sensor portion 13a are disposed to be separated from each other by 90 degrees in the circumferential direction DIRC of the shaft 21a.

In the sensor unit 10a as described above as well, the same operational effects as those of the sensor unit 10 are achieved.

### Second Embodiment

Hereinafter, a sensor unit according to a second embodiment of the present disclosure will be described with reference to the accompanying drawings.

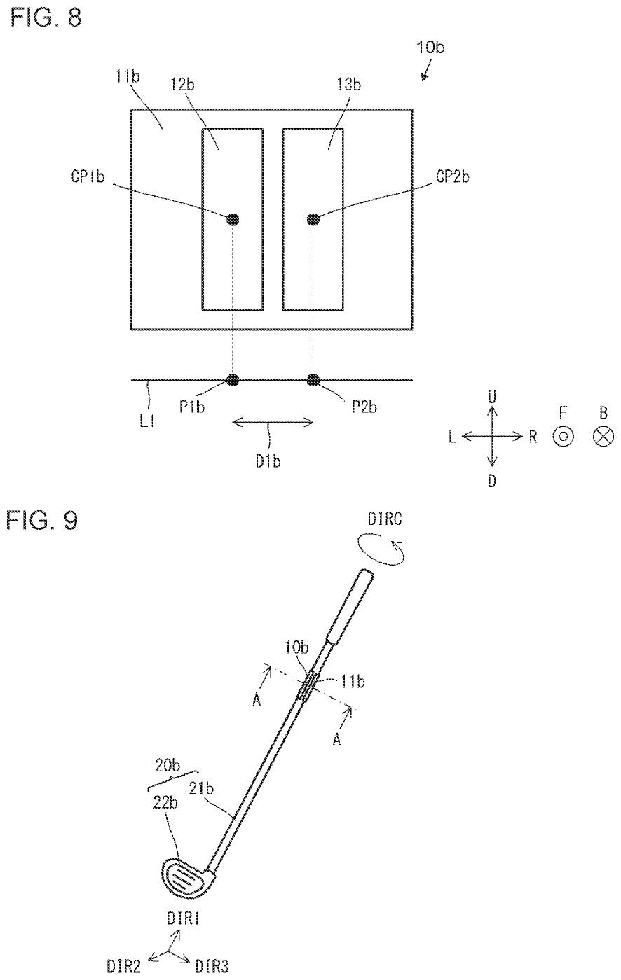

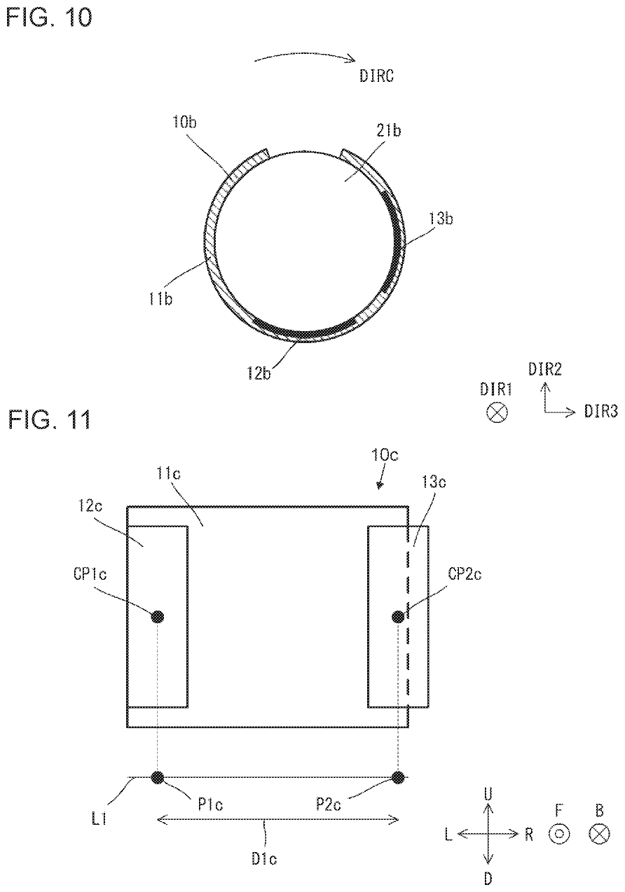

FIG. 8 is a plan view of a sensor unit 10b in a state that a sheet 11b according to the second embodiment is expanded in a plane. FIG. 9 is a perspective view of the sensor unit 10b according to the second embodiment in a state of being attached to a shaft 21b. FIG. 10 is a sectional view of the sensor unit 10b according to the second embodiment in the state of being attached to the shaft 21b taken along a line A-A. In the second embodiment, only portions different from the arrangement structure of the sensor unit according to the first embodiment will be described, and other descriptions will be omitted.

As illustrated in FIG. 8 to FIG. 10, in the state that the sheet 11b is expanded in a plane, a length of each of an upper long side and a lower long side of a front main surface of the sheet 11b, and a length of each of an upper long side and a lower long side of a back main surface of the sheet 11b each are shorter than a circumferential length of a sectional circle of the shaft 21b. Thus, in a state that the sensor unit 10b is attached to the shaft 21b, there is exposed a portion of a circumferential surface of the shaft 21b at the same position, in the first direction DIR1, as a first center point CP1b of a first sensor portion 12b or a second center point CP2b of a second sensor portion 13b.

In the sensor unit 10b as described above as well, the same operational effects as those of the sensor unit 10 are achieved. Further, the sensor unit 10b may easily be positioned while checking the position of the exposed portion of the circumferential surface of the shaft 21b.

### Third Embodiment

Hereinafter, a sensor unit according to a third embodiment of the present disclosure will be described with reference to the accompanying drawings.

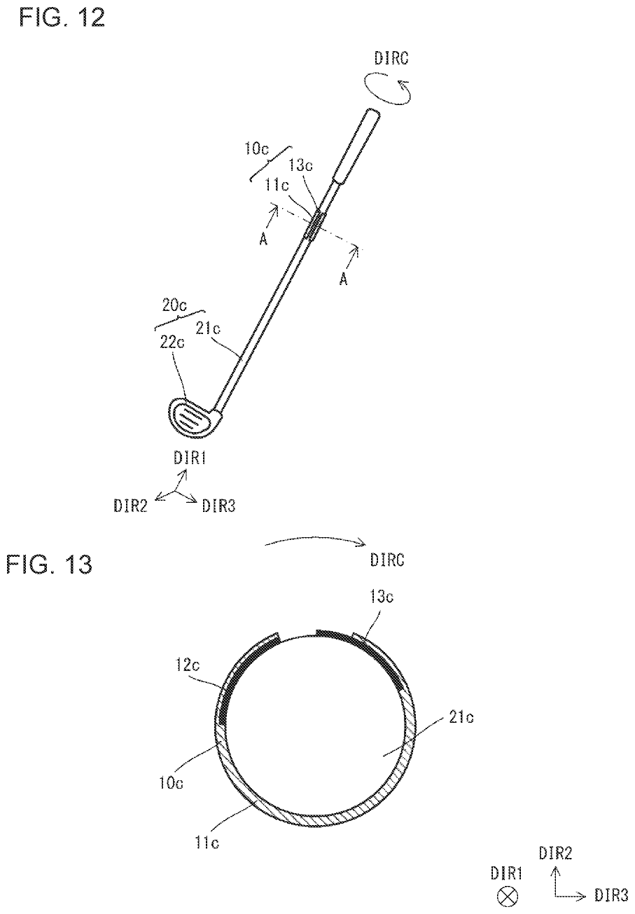

FIG. 11 is a plan view of a sensor unit 10c in a state that a sheet 11c according to the third embodiment is expanded in a plane. FIG. 12 is a perspective view of the sensor unit 10c according to the third embodiment in a state of being attached to a shaft 21c. FIG. 13 is a sectional view of the sensor unit 10c according to the third embodiment in the state of being attached to the shaft 21c taken along a line A-A. In the third embodiment, only portions different from the arrangement structure of the sensor unit according to the first embodiment will be described, and other descriptions will be omitted.

As illustrated in FIG. 11 to FIG. 13, in the state that the sheet 11c is expanded in a plane, a front main surface of a second sensor portion 13c has a portion not overlapping a front main surface of the sheet 11c in a view in the front-back direction. Further, in the state that the sheet 11c is expanded in a plane, a length of each of an upper long side and a lower long side of the front main surface of the sheet 11c, and a length of each of an upper long side and a lower long side of a back main surface of the sheet 11c each are shorter than a circumferential length of a sectional circle of the shaft 21c. Thus, in a state that the sensor unit 10c is attached to the shaft 21c, there is exposed a portion of a circumferential surface of the shaft 21c and a portion of a back main surface of the second sensor portion 13c at the same position, in the first direction DIR1, as a first center point CP1c of a first sensor portion 12c or a second center point CP2c of the second sensor portion 13c.

In the state that the sheet 11c is expanded in a plane, a first distance D1c in the present embodiment is equal to three-fourths of the circumferential length of the sectional circle of the shaft 21c. Thus, the first center point CP1c of the first sensor portion 12c and the second center point CP2c of the second sensor portion 13c are disposed to be separated from each other by 90 degrees in the circumferential direction DIRC of the shaft 21c.

In the sensor unit 10c as described above as well, the same operational effects as those of the sensor unit 10 are achieved. Further, the sensor unit 10c may easily be positioned while checking the position of the exposed portion of the circumferential surface of the shaft 21c. Furthermore, even when the first sensor portion 12c and the second sensor portion 13c receive force in a contraction direction, the force received from the sheet 11c by the first sensor portion 12c and the second sensor portion 13c may be released from the exposed portion of the circumferential surface of the shaft 21c, thereby improving the adhesiveness of the shaft 21c and the first sensor portion 12c and the adhesiveness of the shaft 21c and the second sensor portion 13c.

In the state that the sheet 11c is expanded in a plane, it is sufficient that the front main surface of at least one of the first sensor portion 12c and the second sensor portion 13c has a portion not overlapping the front main surface of the sheet 11c in a view in the front-back direction.

### Fourth Embodiment

Hereinafter, a sensor unit according to a fourth embodiment of the present disclosure will be described with reference to the accompanying drawings.

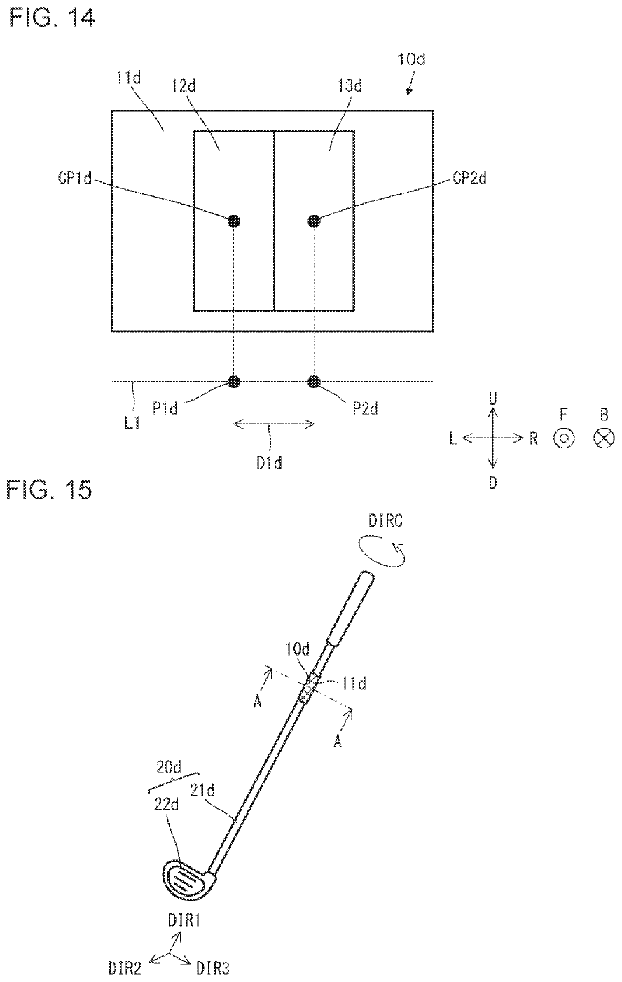

FIG. 14 is a plan view of a sensor unit 10d in a state that a sheet 11d according to the fourth embodiment is expanded in a plane. FIG. 15 is a perspective view of the sensor unit 10d according to the fourth embodiment in a state of being attached to a shaft 21d. FIG. 16 is a sectional view of the sensor unit 10d according to the fourth embodiment in the state of being attached to the shaft 21d taken along a line A-A. In the fourth embodiment, only portions different from the arrangement structure of the sensor unit according to the first embodiment will be described, and other descriptions will be omitted.

As illustrated in FIG. 14 to FIG. 16, part of an outer edge of a front main surface of a first sensor portion 12d and part of an outer edge of a front main surface of a second sensor portion 13d are in contact with each other. In the present embodiment, a right long side of the front main surface of the first sensor portion 12d and a left long side of the front main surface of the second sensor portion 13d are in contact with each other.

In the sensor unit 10d as described above as well, the same operational effects as those of the sensor unit 10 are achieved. Further, in a state that the sensor unit 10d is attached to the shaft 21d, a center point of each of the first sensor portion 12d and the second sensor portion 13d may easily be confirmed, and the sensor unit 10d may more easily be positioned.

Part of the outer edge of the front main surface of the first sensor portion 12d and part of the outer edge of the front main surface of the second sensor portion 13d may be in contact with each other via an adhesive layer having an insulation property.

Part of an outer edge of a back main surface of the first sensor portion 12d and part of an outer edge of a back main surface of the second sensor portion 13d may be in contact with each other. Part of the outer edge of the back main surface of the first sensor portion 12d and part of the outer edge of the back main surface of the second sensor portion 13d may be in contact with each other via an adhesive layer having an insulation property.

### Fifth Embodiment

Hereinafter, a sensor unit according to a fifth embodiment of the present disclosure will be described with reference to the accompanying drawings.

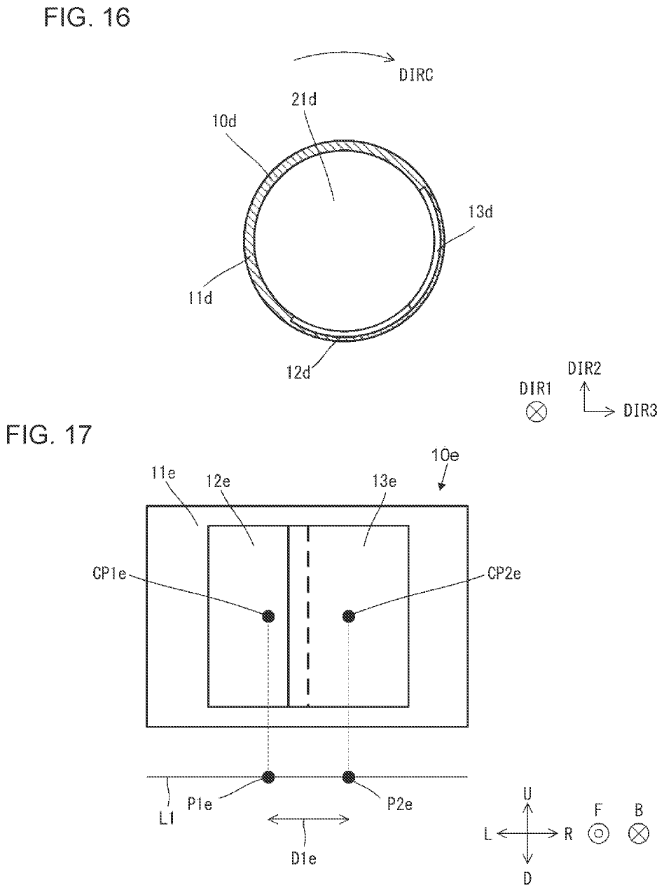

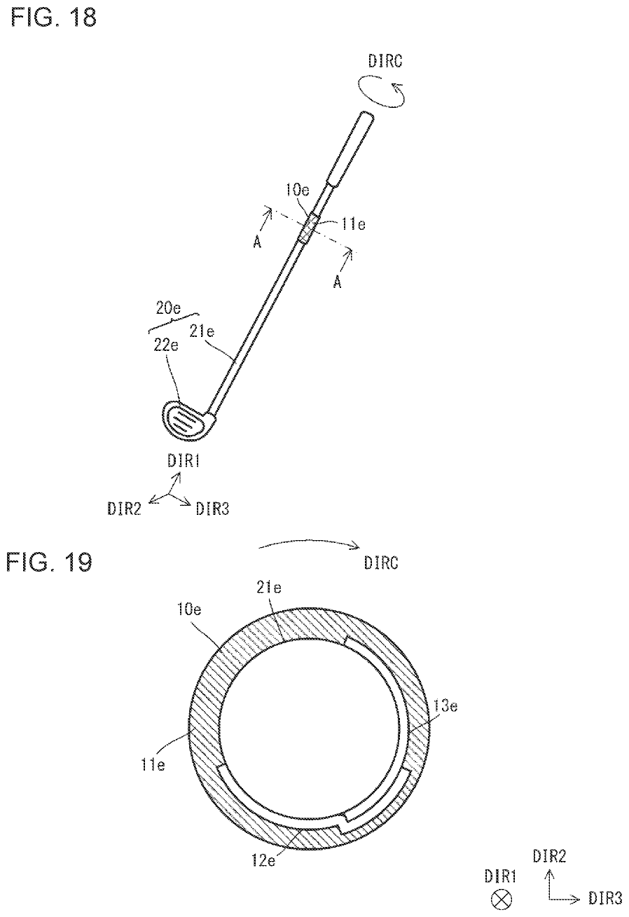

FIG. 17 is a plan view of a sensor unit 10e in a state that a sheet 11e according to the fifth embodiment is expanded in a plane. FIG. 18 is a perspective view of the sensor unit 10e according to the fifth embodiment in a state of being attached to a shaft 21e. FIG. 19 is a sectional view of the sensor unit 10e according to the fifth embodiment in the state of being attached to the shaft 21e taken along a line A-A. In the fifth embodiment, only portions different from the arrangement structure of the sensor unit according to the first embodiment will be described, and other descriptions will be omitted.

As illustrated in FIG. 17 to FIG. 19, in a state that the sheet 11e is expanded in a plane, a front main surface of a first sensor portion 12e has a portion overlapping a front main surface of a second sensor portion 13e in a view in the front-back direction. In a state that the sheet 11e is expanded in a plane, the front main surface of the second sensor portion 13e has a portion overlapping the front main surface of the first sensor portion 12e in a view in the front-back direction.

In the sensor unit 10e as described above as well, the same operational effects as those of the sensor unit 10 are achieved. Further, an area of each of the front main surface and a back main surface of the first sensor portion 12e and an area of each of the front main surface and a back main surface of the second sensor portion 13e may be enlarged. This makes it possible to enlarge an area, for detecting electric charge, of each of the first sensor portion 12e and the second sensor portion 13e. Thus, output-voltage sensitivity of each of the first sensor portion 12e and the second sensor portion 13e may be increased, and the detection accuracy of the sensor unit 10e may be increased.

### Sixth Embodiment

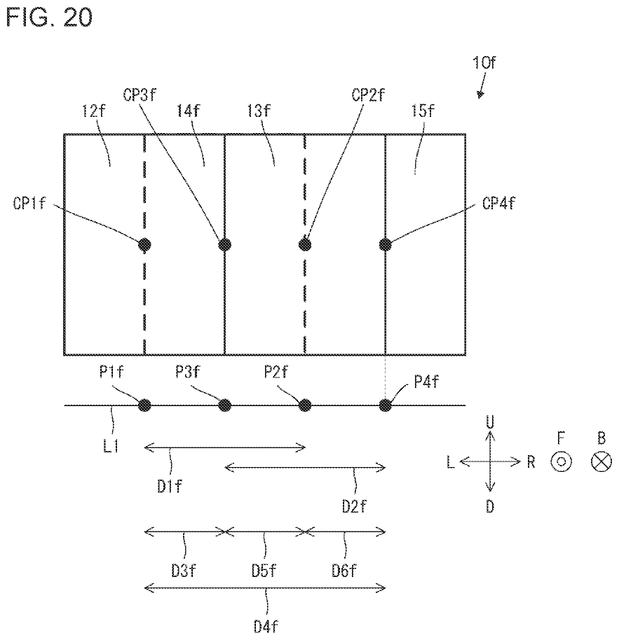

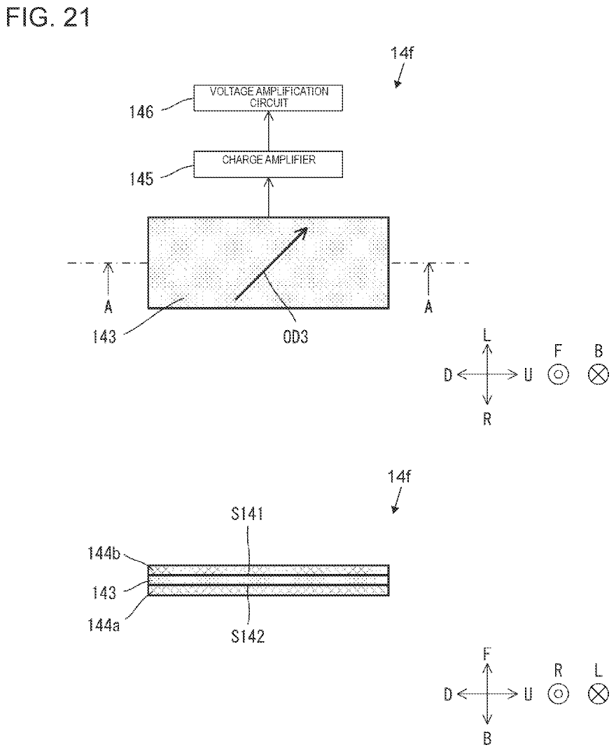

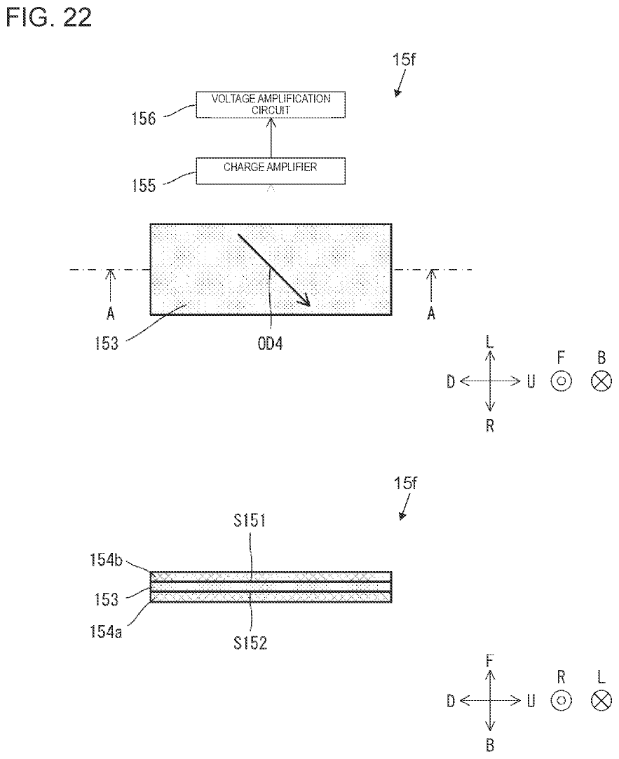

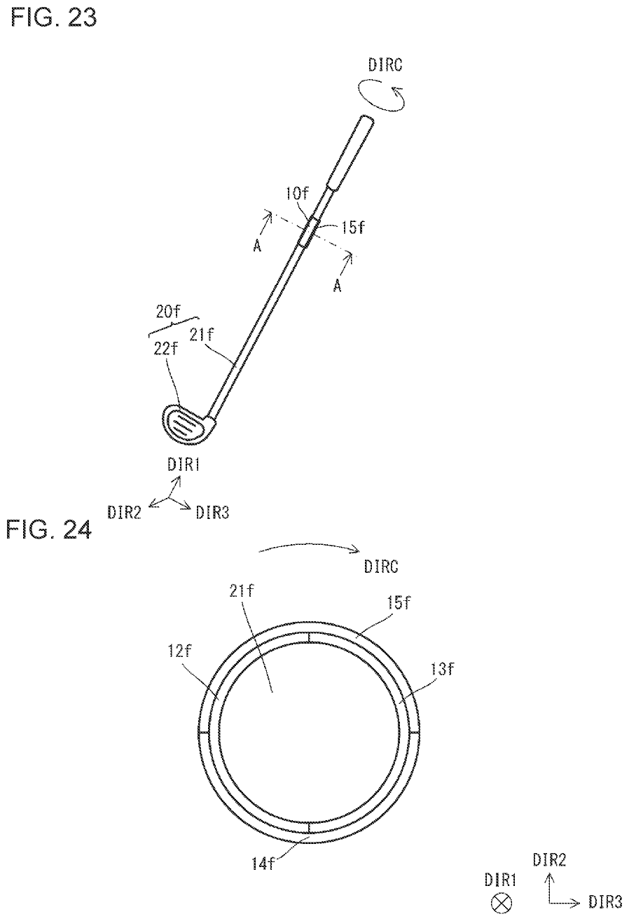

Hereinafter, a sensor unit according to a sixth embodiment of the present disclosure will be described with reference to the accompanying drawings. FIG. 20 is a plan view of a sensor unit 10f in a state that the sensor unit 10f according to the sixth embodiment is expanded in a plane. FIG. 21 is a plan view and a sectional view of a third sensor portion 14f in the state that the sensor unit 10f according to the sixth embodiment is expanded in a plane. FIG. 22 is a plan view and a sectional view of a fourth sensor portion 15f in the state that the sensor unit 10f according to the sixth embodiment is expanded in a plane. FIG. 23 is a perspective view of the sensor unit 10f according to the sixth embodiment in a state of being attached to a shaft 21f. FIG. 24 is a sectional view of the sensor unit 10f according to the sixth embodiment in the state of being attached to the shaft 21f taken along a line A-A. In the sixth embodiment, only portions different from the arrangement structure of the sensor unit according to the first embodiment will be described, and other descriptions will be omitted.

As illustrated in FIG. 20, the sensor unit 10f includes a first sensor portion 12f, a second sensor portion 13f, the third sensor portion 14f, and the fourth sensor portion 15f. The third sensor portion 14f in the present embodiment corresponds to the sheet 11 and 11b to 11e in the first embodiment to the fifth embodiment.

A deformation direction detected by the first sensor portion 12f and a deformation direction detected by the second sensor portion 13f, of the shaft 21f being an object to be measured, are the same.

The third sensor portion 14f detects deformation of the shaft 21f being the object to be measured, and has a film shape. Note that, the deformation direction detected by the first sensor portion 12f and the deformation direction detected by the third sensor portion 14f, of the shaft 21f being the object to be measured, are different from each other. The third sensor portion 14f has a front main surface and a back main surface. A back main surface of the first sensor portion 12f and a back main surface of the second sensor portion 13f each are attached to a front main surface of the third sensor portion 14f.

As illustrated in FIG. 21, the third sensor portion 14f includes a piezoelectric film 143, a first electrode 144a, a second electrode 144b, a charge amplifier 145, and a voltage amplification circuit 146. The piezoelectric film 143 is an example of a piezoelectric body. The piezoelectric film 143 has a sheet shape. The piezoelectric film 143 (third piezoelectric body) has a front main surface S141 and a back main surface S142. In a state that the sensor unit 10f is expanded in a plane, the front main surface S141 and the back main surface S142 of the piezoelectric film 143 (third piezoelectric body) each have a rectangular shape having a left long side and a right long side that are extending in the up-down direction, and an upper short side and a lower short side that are extending in the left-right direction in a view in the front-back direction. In the present embodiment, a longitudinal direction of the piezoelectric film 143 (third piezoelectric body) of the third sensor portion 14f is the up-down direction, and a lateral direction of the piezoelectric film 143 (third piezoelectric body) of the third sensor portion 14f is the left-right direction. In the present embodiment, the piezoelectric film 143 is a PLA film. The PLA film is the same as that of the first embodiment and will not be described. In the present embodiment, a uniaxial extension axis OD3 of the piezoelectric film 143 (third piezoelectric body) forms an angle of 45 degrees counterclockwise relative to the up-down direction. That is, the piezoelectric film 143 (third piezoelectric body) is extended in at least one axial direction.

The first electrode 144a is a signal electrode. As illustrated in FIG. 21, the first electrode 144a is provided on the back main surface S142. The first electrode 144a covers the back main surface S142. The first electrode 144a is an organic electrode such as indium tin oxide (ITO) and zinc oxide (ZnO), a metal coat formed by vapor deposition or plating, or a printed electrode film formed by silver paste, for example.

The second electrode 144b is a ground electrode. The second electrode 144b is coupled to the ground electric potential. As illustrated in FIG. 21, the second electrode 144b is provided on the front main surface S141. Thus, the piezoelectric film 143 is positioned between the first electrode 144a and the second electrode 144b. The second electrode 144b covers the front main surface S141. The second electrode 144b is an organic electrode such as indium tin oxide (ITO) and zinc oxide (ZnO), a metal coat formed by vapor deposition or plating, or a printed electrode film formed by silver paste, for example.

The charge amplifier 145 converts electric charge generated by the piezoelectric film 143 into a detection signal, being a voltage signal, and outputs the detection signal to the voltage amplification circuit 146. The voltage amplification circuit 146 amplifies and outputs the detection signal.

In the state that the sensor unit 10f is expanded in a plane, a length of each of an upper short side and a lower short side of the front main surface of the third sensor portion 14f, and a length of each of an upper short side and a lower short side of a back main surface of the third sensor portion 14f each are shorter than a circumferential length of a sectional circle of the shaft 21f being an object to be measured.

The third sensor portion 14f described above is fixed to the first sensor portion 12f and the second sensor portion 13f via an adhesive layer (not illustrated). The adhesive layer has an insulation property. Specifically, the adhesive layer fixes a left portion of the second electrode 144b and a right portion of the back main surface of the first sensor portion 12f. That is, a left portion of the front main surface of the third sensor portion 14f is fixed to the right portion of the back main surface of the first sensor portion 12f. Thus, a left portion of the third sensor portion 14f overlaps a right portion of the first sensor portion 12f in a view in the front-back direction. That is, in the state that the sensor unit 10f is expanded in a plane, the front main surface of the third sensor portion 14f has a portion overlapping the front main surface of the first sensor portion 12f in a view in the front-back direction.

The adhesive layer fixes a right portion of the second electrode 144b and a left portion of a back main surface of the second sensor portion 13f. That is, a right portion of the front main surface of the third sensor portion 14f is fixed to the left portion of the back main surface of the second sensor portion 13f. Thus, a right portion of the third sensor portion 14f overlaps a left portion of the second sensor portion 13f in a view in the front-back direction. That is, in the state that the sensor unit 10f is expanded in a plane, the front main surface of the third sensor portion 14f has a portion overlapping the front main surface of the second sensor portion 13f in a view in the front-back direction.

The fourth sensor portion 15f detects deformation of the shaft 21f being the object to be measured, and has a film shape. Note that, a deformation direction detected by the third sensor portion 14f and a deformation direction detected by the fourth sensor portion 15f, of the shaft 21f being the object to be measured, are the same. The fourth sensor portion 15f has a front main surface and a back main surface. As illustrated in FIG. 22, the fourth sensor portion 15f includes a piezoelectric film 153, a first electrode 154a, a second electrode 154b, a charge amplifier 155, and a voltage amplification circuit 156. The piezoelectric film 153 has a sheet shape. The piezoelectric film 153 (fourth piezoelectric body) has a front main surface S151 and a back main surface S152. In the state that the sensor unit 10f is expanded in a plane, the front main surface S151 and the back main surface S152 of the piezoelectric film 153 (fourth piezoelectric body) each have a rectangular shape having a left long side and a right long side that are extending in the up-down direction, and an upper short side and a lower short side that are extending in the left-right direction in a view in the front-back direction. In the present embodiment, a longitudinal direction of the piezoelectric film 153 (fourth piezoelectric body) is the up-down direction, and a lateral direction of the piezoelectric film 153 (fourth piezoelectric body) is the left-right direction. In the present embodiment, the piezoelectric film 153 is a PLA film. The PLA film is the same as that of the first embodiment and will not be described. In the present embodiment, a uniaxial extension axis OD4 of the piezoelectric film 153 (fourth piezoelectric body) forms an angle of 45 degrees clockwise relative to the up-down direction. That is, the piezoelectric film 153 (fourth piezoelectric body) is extended in at least one axial direction.

The first electrode 154a is a signal electrode. As illustrated in FIG. 22, the first electrode 154a is provided on the back main surface S152. The first electrode 154a covers the back main surface S152. The first electrode 154a is an organic electrode such as indium tin oxide (ITO) and zinc oxide (ZnO), a metal coat formed by vapor deposition or plating, or a printed electrode film formed by silver paste, for example.

The second electrode 154b is a ground electrode. The second electrode 154b is coupled to the ground electric potential. As illustrated in FIG. 22, the second electrode 154b is provided on the front main surface S151. Thus, the piezoelectric film 153 is positioned between the first electrode 154a and the second electrode 154b. The second electrode 154b covers the front main surface S151. The second electrode 154b is an organic electrode such as indium tin oxide (ITO) and zinc oxide (ZnO), a metal coat formed by vapor deposition or plating, or a printed electrode film formed by silver paste, for example.

The charge amplifier 155 converts electric charge generated by the piezoelectric film 153 into a detection signal, being a voltage signal, and outputs the detection signal to the voltage amplification circuit 156. The voltage amplification circuit 156 amplifies and outputs the detection signal.

In the state that the sensor unit 10f is expanded in a plane, a length of each of an upper short side and a lower short side of the front main surface of the fourth sensor portion 15f, and a length of each of an upper short side and a lower short side of a back main surface of the fourth sensor portion 15f each are shorter than the circumferential length of the sectional circle of the shaft 21f being the object to be measured.

The fourth sensor portion 15f described above is fixed to the second sensor portion 13f via an adhesive layer (not illustrated). The adhesive layer has an insulation property. Specifically, the adhesive layer fixes a left portion of the second electrode 154b and a right portion of the back main surface of the second sensor portion 13f. That is, a left portion of the front main surface of the fourth sensor portion 15f is fixed to the right portion of the back main surface of the second sensor portion 13f. Thus, a left portion of the fourth sensor portion 15f overlaps a right portion of the second sensor portion 13f in a view in the front-back direction. That is, in the state that the sensor unit 10f is expanded in a plane, the front main surface of the fourth sensor portion 15f has a portion overlapping the front main surface of the second sensor portion 13f in a view in the front-back direction.

As illustrated in FIG. 20, in the state that the sensor unit 10f is expanded in a plane, a sum of a length of an upper short side of the front main surface of the first sensor portion 12f and a length of an upper short side of the front main surface of the second sensor portion 13f is equal to or greater than the circumferential length of the sectional circle of the shaft 21f being the object to be measured.

In the state that the sensor unit 10f is expanded in a plane, a sum of the length of the upper short side of the front main surface of the third sensor portion 14f and the length of the upper short side of the front main surface of the fourth sensor portion 15f is equal to or greater than the circumferential length of the sectional circle of the shaft 21f being the object to be measured.

In the state that the sensor unit 10f is expanded in a plane, the front main surface of the first sensor portion 12f is disposed at a position not overlapping the front main surface of the second sensor portion 13f in a view in the front-back direction. That is, in the state that the sensor unit 10f is expanded in a plane, the front main surface of the first sensor portion 12f has a portion not overlapping the front main surface of the second sensor portion 13f in a view in the front-back direction. An adhesive layer (not illustrated) is provided on the front main surface of the first sensor portion 12f. The adhesive layer has an insulation property.

In the state that the sensor unit 10f is expanded in a plane, the front main surface of the second sensor portion 13f is disposed at a position not overlapping the front main surface of the first sensor portion 12f in a view in the front-back direction. That is, in the state that the sensor unit 10f is expanded in a plane, the front main surface of the second sensor portion 13f has a portion not overlapping the front main surface of the first sensor portion 12f in a view in the front-back direction. An adhesive layer (not illustrated) is provided on the front main surface of the second sensor portion 13f. The adhesive layer has an insulation property.

In the state that the sensor unit 10f is expanded in a plane, the front main surface of the third sensor portion 14f is disposed at a position not overlapping the front main surface of the fourth sensor portion 15f in a view in the front-back direction. That is, in the state that the sensor unit 10f is expanded in a plane, the front main surface of the third sensor portion 14f has a portion not overlapping the front main surface of the fourth sensor portion 15f in a view in the front-back direction.

In the state that the sensor unit 10f is expanded in a plane, the front main surface of the fourth sensor portion 15f is disposed at a position not overlapping the front main surface of the third sensor portion 14f in a view in the front-back direction. That is, in the state that the sensor unit 10f is expanded in a plane, the front main surface of the fourth sensor portion 15f has a portion not overlapping the front main surface of the third sensor portion 14f in a view in the front-back direction. The fourth sensor portion 15f is positioned to the right of the third sensor portion 14f.

In the state that the sensor unit 10f is expanded in a plane, part of an outer edge of the front main surface of the first sensor portion 12f and part of an outer edge of the front main surface of the second sensor portion 13f are in contact with each other. In the present embodiment, a right long side of the front main surface of the first sensor portion 12f and a left long side of the front main surface of the second sensor portion 13f are in contact with each other. Part of an outer edge of the main surface of the third sensor portion 14f and part of an outer edge of the main surface of the fourth sensor portion 15f are in contact with each other. In the present embodiment, a right long side of the front main surface of the third sensor portion 14f and a left long side of the front main surface of the fourth sensor portion 15f are in contact with each other.

As illustrated in FIG. 20, in the state that the sensor unit 10f is expanded in a plane, long sides of the first sensor portion 12f are parallel to each other, long sides of the second sensor portion 13f are parallel to each other, long sides of the third sensor portion 14f are parallel to each other, and long sides of the fourth sensor portion 15f are parallel to each other. In the state that the sensor unit 10f is expanded in a plane, short sides of the first sensor portion 12f are parallel to each other, short sides of the second sensor portion 13f are parallel to each other, short sides of the third sensor portion 14f are parallel to each other, and short sides of the fourth sensor portion 15f are parallel to each other.

As illustrated in FIG. 20, in the state that the sensor unit 10f is expanded in a plane, a third center point CP3f of the third sensor portion 14f is defined in a view in the front-back direction. The third center point CP3f is a center of gravity of the front main surface of the third sensor portion 14f, for example. The third center point CP3f may be a center of gravity of the back main surface of the third sensor portion 14f, for example. The third center point CP3f may be a center of the front main surface of the third sensor portion 14f, for example. At this time, when two diagonal lines are defined on the front main surface of the third sensor portion 14f, for example, the two diagonal lines intersect with each other at the third center point CP3f. When a straight line connecting midpoints of the two short sides and a straight line connecting midpoints of the two long sides are defined on the front main surface of the third sensor portion 14f, for example, the straight line connecting the midpoints of the two short sides and the straight line connecting the midpoints of the two long sides intersect with each other at the third center point CP3f. The third center point CP3f may be a center of the back main surface of the third sensor portion 14f, for example. At this time, when two diagonal lines are defined on the back main surface of the third sensor portion 14f, for example, the two diagonal lines intersect with each other at the third center point CP3f. When a straight line connecting midpoints of the two short sides and a straight line connecting midpoints of the two long sides are defined on the back main surface of the third sensor portion 14f, for example, the straight line connecting the midpoints of the two short sides and the straight line connecting the midpoints of the two long sides intersect with each other at the third center point CP3f.

Similarly, in the state that the sensor unit 10f is expanded in a plane, a fourth center point CP4f of the fourth sensor portion 15f is defined in a view in the front-back direction. The fourth center point CP4f is a center of gravity of the front main surface of the fourth sensor portion 15f, for example. The fourth center point CP4f may be a center of gravity of the back main surface of the fourth sensor portion 15f, for example. The fourth center point CP4f may be a center of the front main surface of the fourth sensor portion 15f, for example. At this time, when two diagonal lines are defined on the front main surface of the fourth sensor portion 15f, for example, the two diagonal lines intersect with each other at the fourth center point CP4f. When a straight line connecting midpoints of the two short sides and a straight line connecting midpoints of the two long sides are defined on the front main surface of the fourth sensor portion 15f, for example, the straight line connecting the midpoints of the two short sides and the straight line connecting the midpoints of the two long sides intersect with each other at the fourth center point CP4f. The fourth center point CP4f may be a center of the back main surface of the fourth sensor portion 15f, for example. At this time, when two diagonal lines are defined on the back main surface of the fourth sensor portion 15f, for example, the two diagonal lines intersect with each other at the fourth center point CP4f. When a straight line connecting midpoints of the two short sides and a straight line connecting midpoints of the two long sides are defined on the back main surface of the fourth sensor portion 15f, for example, the straight line connecting the midpoints of the two short sides and the straight line connecting the midpoints of the two long sides intersect with each other at the fourth center point CP4f.

As illustrated in FIG. 20, in the state that the sensor unit 10f is expanded in a plane, there is defined any straight line Li extending in the left-right direction in a view in the front-back direction. In the state that the sensor unit 10f is expanded in a plane, an intersection point of the straight line Li and a perpendicular line drawn from a first center point CP1f to the straight line Li, in a view in the front-back direction, is defined as a first intersection point P1f. An intersection point of the straight line Li and a perpendicular line drawn from the second center point CP2f to the straight line Li, in a view in the front-back direction, is defined as a second intersection point P2f. An intersection point of the straight line Li and a perpendicular line drawn from the third center point CP3f to the straight line Li, in a view in the front-back direction, is defined as a third intersection point P3f. An intersection point of the straight line Li and a perpendicular line drawn from the fourth center point CP4f to the straight line Li, in a view in the front-back direction, is defined as a fourth intersection point P4f. A distance between the first intersection point P1f and the second intersection point P2f is defined as a first distance D1f. A distance between the third intersection point P3f and the fourth intersection point P4f is defined as a second distance D2f. A distance between the first intersection point P1f and the third intersection point P3f is defined as a third distance D3f. A distance between the first intersection point P1f and the fourth intersection point P4f is defined as D4f. A distance between the second intersection point P2f and the third intersection point P3f is defined as D5f. A distance between the second intersection point P2f and the fourth intersection point P4f is defined as D6f.

In the state that the sensor unit 10f is expanded in a plane, the first distance D1f of the present embodiment is equal to one-half of the circumferential length of the sectional circle of the shaft 21f being the object to be measured. In the state that the sensor unit 10f is expanded in a plane, the second distance D2f of the present embodiment is equal to one-half of the circumferential length of the sectional circle of the shaft 21f being the object to be measured. In the state that the sensor unit 10f is expanded in a plane, the third distance D3f of the present embodiment is equal to one-fourth of the circumferential length of the sectional circle of the shaft 21f being the object to be measured. In the state that the sensor unit 10f is expanded in a plane, the fourth distance D4f of the present embodiment is equal to three-fourths of the circumferential length of the sectional circle of the shaft 21f being the object to be measured. In the state that the sensor unit 10f is expanded in a plane, the fifth distance D5f of the present embodiment is equal to one-fourth of the circumferential length of the sectional circle of the shaft 21f being the object to be measured. In the state that the sensor unit 10f is expanded in a plane, the sixth distance D6f of the present embodiment is equal to one-fourth of the circumferential length of the sectional circle of the shaft 21f being the object to be measured.

As illustrated in FIG. 23, the sensor unit 10f is attached to a circumferential surface of the shaft 21f. Specifically, the front main surface of the first sensor portion 12f and the front main surface of the second sensor portion 13f each are fixed to the shaft 21f by an adhesive layer (not illustrated) provided on the front main surface of the first sensor portion 12f and the front main surface of the second sensor portion 13f. In a state that the sensor unit 10f is attached to the shaft 21f, a direction in which each of the upper short side and the lower short side of the first sensor portion 12f extends, a direction in which each of the upper short side and the lower short side of the second sensor portion 13f extends, a direction in which each of the upper short side and the lower short side of the third sensor portion 14f extends, and a direction in which each of the upper short side and the lower short side of the fourth sensor portion 15f extends each are the same direction as the circumferential direction DIRC.

As illustrated in FIG. 24, in the state that the sensor unit 10f is attached to the shaft 21f, the first sensor portion 12f and the second sensor portion 13f are disposed between the shaft 21f and the third sensor portion 14f, and between the shaft 21f and the fourth sensor portion 15f. The first sensor portion 12f and the second sensor portion 13f each detect deformation of the shaft 21f in the third direction DIR3. The third sensor portion 14f and the fourth sensor portion 15f each detect deformation of the shaft 21f in the second direction DIR2.

In the state that the sensor unit 10f is attached to the shaft 21f, a left portion of the first sensor portion 12f overlaps a right portion of the fourth sensor portion 15f in a view in the third direction DIR3. A left long side of the front main surface of the first sensor portion 12f and a right long side of the front main surface of the second sensor portion 13f are in contact with each other. A left long side of the front main surface of the third sensor portion 14f and a right long side of the front main surface of the fourth sensor portion 15f are in contact with each other.

As described above, a direction in which each of the upper short side and the lower short side of the first sensor portion 12f extends, a direction in which each of the upper short side and the lower short side of the second sensor portion 13f extends, a direction in which each of the upper short side and the lower short side of the third sensor portion 14f extends, and a direction in which each of the upper short side and the lower short side of the fourth sensor portion 15f extends each are the same direction as the circumferential direction DIRC. Thus, the first distance D1f is equal to a distance in the circumferential direction DIRC between the first center point CP1f of the first sensor portion 12f and the second center point CP2f of the second sensor portion 13f. Similarly, the second distance D2f is equal to a distance in the circumferential direction DIRC between the third center point CP3f of the third sensor portion 14f and the fourth center point CP4f of the fourth sensor portion 15f. Similarly, the third distance D3f is equal to a distance in the circumferential direction DIRC between the first center point CP1f of the first sensor portion 12f and the third center point CP3f of the third sensor portion 14f. Similarly, the fourth distance D4f is equal to a distance in the circumferential direction DIRC between the first center point CP1f of the first sensor portion 12f and the fourth center point CP4f of the fourth sensor portion 15f. Similarly, the fifth distance D5f is equal to a distance in the circumferential direction DIRC between the second center point CP2f of the second sensor portion 13f and the third center point CP3f of the third sensor portion 14f. Similarly, the sixth distance D6f is equal to a distance in the circumferential direction DIRC between the second center point CP2f of the second sensor portion 13f and the fourth center point CP4f of the fourth sensor portion 15f.

As described above, in the state that the sensor unit 10f is expanded in a plane, the first distance D1f is equal to one-half of the circumferential length of the sectional circle of the shaft 21f. Thus, the first center point CP1f of the first sensor portion 12f and the second center point CP2f of the second sensor portion 13f are disposed to be separated from each other by 180 degrees in the circumferential direction DIRC of the shaft 21f. As described above, in the state that the sensor unit 10f is expanded in a plane, the second distance D2f is equal to one-half of the circumferential length of the sectional circle of the shaft 21f. Thus, the third center point CP3f of the third sensor portion 14f and the fourth center point CP4f of the fourth sensor portion 15f are disposed to be separated from each other by 180 degrees in the circumferential direction DIRC of the shaft 21f. As described above, in the state that the sensor unit 10f is expanded in a plane, the third distance D3f is equal to one-fourth of the circumferential length of the sectional circle of the shaft 21f. Thus, the first center point CP1f of the first sensor portion 12f and the third center point CP3f of the third sensor portion 14f are disposed to be separated from each other by 90 degrees in the circumferential direction DIRC of the shaft 21f. As described above, in the state that the sensor unit 10f is expanded in a plane, the fourth distance D4f is equal to three-fourths of the circumferential length of the sectional circle of the shaft 21f. Thus, the first center point CP1f of the first sensor portion 12f and the fourth center point CP4f of the fourth sensor portion 15f are disposed to be separated from each other by 90 degrees in the circumferential direction DIRC of the shaft 21f. As described above, in the state that the sensor unit 10f is expanded in a plane, the fifth distance D5f is equal to one-fourth of the circumferential length of the sectional circle of the shaft 21f. Thus, the second center point CP2f of the second sensor portion 13f and the third center point CP3f of the third sensor portion 14f are disposed to be separated from each other by 90 degrees in the circumferential direction DIRC of the shaft 21f. As described above, in the state that the sensor unit 10f is expanded in a plane, the sixth distance D6f is equal to one-fourth of the circumferential length of the sectional circle of the shaft 21f. Thus, the second center point CP2f of the second sensor portion 13f and the fourth center point CP4f of the fourth sensor portion 15f are disposed to be separated from each other by 90 degrees in the circumferential direction DIRC of the shaft 21f.

In the sensor unit 10f as described above as well, the same operational effects as those of the sensor unit 10 are achieved. Further, an area of each of the front main surface and the back main surface of each of the first sensor portion 12f, the second sensor portion 13f, the third sensor portion 14f, and the fourth sensor portion 15f may be enlarged. This makes it possible to enlarge an area for detecting electric charge of each of the first sensor portion 12f, the second sensor portion 13f, the third sensor portion 14f, and the fourth sensor portion 15f. Thus, output-voltage sensitivity of each of the first sensor portion 12f, the second sensor portion 13f, the third sensor portion 14f, and the fourth sensor portion 15f may be increased, and the detection accuracy of the sensor unit 10f may be increased.

When the shaft 21f is deformed in the second direction DIR2, the polarity of the electric charge generated by the piezoelectric film 143 and the polarity of the electric charge generated by the piezoelectric film 153 are equal to each other. This makes it possible to easily add a detection signal of the third sensor portion 14f and a detection signal of the fourth sensor portion 15f.

In the state that the sensor unit 10f is expanded in a plane, the uniaxial extension axis OD3 of the piezoelectric film 143 (third piezoelectric body) is not limited to have an angle of 45 degrees counterclockwise relative to the up-down direction, and may have another angle. Further, in the state that the sensor unit 10f is expanded in a plane, the uniaxial extension axis OD4 of the piezoelectric film 153 (fourth piezoelectric body) is not limited to have an angle of 45 degrees clockwise relative to the up-down direction, and may have another angle.

For example, in the state that the sensor unit 10f is expanded in a plane, the uniaxial extension axis OD3 of the piezoelectric film 143 (third piezoelectric body) may form an angle of 45 degrees clockwise relative to the up-down direction. Note that the angle of 45 degrees includes an angle of 45 degrees plus or minus approximately 10 degrees, for example. In the state that the sensor unit 10f is expanded in a plane, the uniaxial extension axis OD4 of the piezoelectric film 153 (fourth piezoelectric body) may form an angle of 45 degrees counterclockwise relative to the up-down direction. Note that the angle of 45 degrees includes an angle of 45 degrees plus or minus approximately 10 degrees, for example. In the configuration above as well, the same effects as those of the sensor unit 10f are achieved.

For example, in the state that the sensor unit 10f is expanded in a plane, each of the uniaxial extension axis OD3 of the piezoelectric film 143 (third piezoelectric body) and the uniaxial extension axis OD4 of the piezoelectric film 153 (fourth piezoelectric body) may form an angle of 0 degrees counterclockwise or 180 degrees counterclockwise relative to the up-down direction. Note that the angle of 0 degrees or the angle of 180 degrees includes an angle of 0 degrees plus or minus approximately 10 degrees or an angle of 180 degrees plus or minus approximately 10 degrees, for example. In the configuration above, it is possible to make a direction, in which the piezoelectric property of the piezoelectric film 143 (third piezoelectric body) is the highest, coincide with a direction of torsion relative to the up-down direction and the left-right direction. Further, it is possible to make a direction, in which the piezoelectric property of the piezoelectric film 153 (fourth piezoelectric body) is the highest, coincide with a direction of torsion relative to the up-down direction and the left-right direction.

For example, in the state that the sensor unit 10f is expanded in a plane, the uniaxial extension axis OD3 of the piezoelectric film 143 (third piezoelectric body) and the uniaxial extension axis OD4 of the piezoelectric film 153 (fourth piezoelectric body) may form an angle of 90 degrees counterclockwise or −90 degrees counterclockwise relative to the up-down direction. Note that the angle of 90 degrees or the angle of −90 degrees includes an angle of 90 degrees plus or minus approximately 10 degrees or an angle of −90 degrees plus or minus approximately 10 degrees, for example. In the configuration above, it is possible to make a direction, in which the piezoelectric property of the piezoelectric film 143 (third piezoelectric body) is the highest, coincide with a direction of torsion relative to the up-down direction and the left-right direction. Further, it is possible to make a direction, in which the piezoelectric property of the piezoelectric film 153 (fourth piezoelectric body) is the highest, coincide with a direction of torsion relative to the up-down direction and the left-right direction.

In the present embodiment, in the sensor unit 10f, each of the third sensor portion 14f and the fourth sensor portion 15f includes a film having PLA and extended in at least one axial direction. From a viewpoint of detecting deformation of an object to be measured, however, each of the third sensor portion 14f and the fourth sensor portion 15f may include a material including another piezoelectric body. Each of the third sensor portion 14f and the fourth sensor portion 15f may include a material having no piezoelectric property.

For example, each of the third sensor portion 14f and the fourth sensor portion 15f may have the d31 piezoelectric constant. Each of the third sensor portion 14f and the fourth sensor portion 15f having the d31 piezoelectric constant is a polyvinylidene fluoride (PVDF) film, for example.

The deformation detection of an object to be measured may be the detection of deformation amount itself.

For example, each of the third sensor portion 14f and the fourth sensor portion 15f may include a strain gauge.

The deformation detection of an object to be measured may be flexure detection of an object to be measured or torsion detection of an object to be measured.

The first electrode 144a may be provided on the front main surface S141. The second electrode 144b may be provided on the back main surface S142. The first electrode 154a may be provided on the front main surface S151. The second electrode 154b may be provided on the back main surface S152.

Note that one charge amplifier may be commonly used as the charge amplifier 145 and the charge amplifier 155. Similarly, one voltage amplification circuit may be commonly used as the voltage amplification circuit 146 and the voltage amplification circuit 156. Thus, it is possible to convert the sum of electric charge generated by the piezoelectric film 143 and electric charge generated by the piezoelectric film 153 into a detection signal being a voltage signal, amplify the detection signal, and output the detection signal.

In the state that the sensor unit 10f is expanded in a plane, it is sufficient that the front main surface of the third sensor portion 14f is disposed at a position overlapping the front main surface of the first sensor portion 12f or the front main surface of the second sensor portion 13f in a view in the front-back direction. That is, in the state that the sensor unit 10f is expanded in a plane, it is sufficient that the front main surface of the third sensor portion 14f has a portion overlapping the front main surface of the first sensor portion 12f or the front main surface of the second sensor portion 13f in a view in the front-back direction.

In the state that the sensor unit 10f is expanded in a plane, it is sufficient that the front main surface of the fourth sensor portion 15f is disposed at a position overlapping the front main surface of the first sensor portion 12f or the front main surface of the second sensor portion 13f in a view in the front-back direction. That is, in the state that the sensor unit 10f is expanded in a plane, it is sufficient that the front main surface of the fourth sensor portion 15f has a portion overlapping the front main surface of the first sensor portion 12f or the front main surface of the second sensor portion 13f in a view in the front-back direction.

In the state that the sensor unit 10f is expanded in a plane, each of the front main surface and the back main surface of the third sensor portion 14f may have a rectangular shape having short sides extending in the up-down direction and long sides extending in the left-right direction in a view in the front-back direction. Further, in the state that the sensor unit 10f is expanded in a plane, each of the front main surface and the back main surface of the fourth sensor portion 15f may have a rectangular shape having short sides extending in the up-down direction and long sides extending in the left-right direction in a view in the front-back direction.

In the state that the sensor unit 10f is expanded in a plane, the sum of a first length and a second length below may be longer than the circumferential length of the sectional circle of the shaft 21f. The first length is a length of the first sensor portion 12f in any one of the upper short side of the front main surface, the lower short side of the front main surface, the upper short side of the back main surface, and the lower short side of the back main surface. The second length is a length of the second sensor portion 13f in any one of the upper short side of the front main surface, the lower short side of the front main surface, the upper short side of the back main surface, and the lower short side of the back main surface. In the state that the sensor unit 10f is attached to the shaft 21f, in a view in the first direction DIR1, the sum of the number of first intersections and the number of second intersections below may be three or more. At the first intersection, any straight line orthogonal to the first direction DIR1 and the front main surface of the first sensor portion 12f intersect with each other, and at the second intersection, any straight line orthogonal to the first direction DIR1 and the front main surface of the second sensor portion 13f intersect with each other.

In the state that the sensor unit 10f is expanded in a plane, the sum of the length of the upper short side of the front main surface of the first sensor portion 12f and the length of the upper short side of the front main surface of the second sensor portion 13f may be equal to the circumferential length of the sectional circle of the shaft 21f.

In the state that the sensor unit 10f is expanded in a plane, the sum of the length of the upper short side of the front main surface of the first sensor portion 12f and the length of the upper short side of the front main surface of the second sensor portion 13f may be shorter than the circumferential length of the sectional circle of the shaft 21f.

In the state that the sensor unit 10f is expanded in a plane, the sum of the length of the upper short side of the front main surface of the third sensor portion 14f and the length of the upper short side of the front main surface of the fourth sensor portion 15f may be longer than the circumferential length of the sectional circle of the shaft 21f. In the state that the sensor unit 10f is attached to the shaft 21f, in a view in the first direction DIR1, the sum of the number of third intersections and the number of fourth intersections below may be three or more. At the third intersection, any straight line orthogonal to the first direction DIR1 and the front main surface of the third sensor portion 14f intersect with each other, and at the fourth intersection, any straight line orthogonal to the first direction DIR1 and the front main surface of the fourth sensor portion 15f intersect with each other.

In the state that the sensor unit 10f is expanded in a plane, the sum of the length of the upper short side of the front main surface of the third sensor portion 14f, and the length of the upper short side or the lower short side of the front main surface of the fourth sensor portion 15f may be equal to the circumferential length of the sectional circle of the shaft 21f.

In the state that the sensor unit 10f is expanded in a plane, the sum of the length of the upper short side of the front main surface of the third sensor portion 14f, and the length of the upper short side of the front main surface of the fourth sensor portion 15f may be shorter than the circumferential length of the sectional circle of the shaft 21f.

In the state that the sensor unit 10f is expanded in a plane, each of the front main surface and the back main surface of the third sensor portion 14f need not have a rectangular shape. For example, each of the front main surface and the back main surface of the third sensor portion 14f may have an elliptical shape or a square shape. In the state that the sensor unit 10f is expanded in a plane, each of the front main surface and the back main surface of the fourth sensor portion 15f need not have a rectangular shape. For example, each of the front main surface and the back main surface of the fourth sensor portion 15f may have an elliptical shape or a square shape.

In the state that the sensor unit 10f is expanded in a plane, the first distance D1f need not be equal to one-half of the circumferential length of the sectional circle of the shaft 21f. For example, in the state that the sensor unit 10f is expanded in a plane, in a case that the first distance D1f is equal to one-sixth of the circumferential length of the sectional circle of the shaft 21f, the first center point CP1f of the first sensor portion 12f and the second center point CP2f of the second sensor portion 13f are disposed to be separated from each other by 60 degrees in the circumferential direction DIRC of the shaft 21f in the state that the sensor unit 10f is attached to the shaft 21f.

In the state that the sensor unit 10f is expanded in a plane, the second distance D2f need not be equal to one-half of the circumferential length of the sectional circle of the shaft 21f. For example, in the state that the sensor unit 10f is expanded in a plane, in a case that the second distance D2f is equal to one-sixth of the circumferential length of the sectional circle of the shaft 21f, the third center point CP3f of the third sensor portion 14f and the fourth center point CP4f of the fourth sensor portion 15f are disposed to be separated from each other by 60 degrees in the circumferential direction DIRC of the shaft 21f in the state that the sensor unit 10f is attached to the shaft 21f.

In the state that the sensor unit 10f is expanded in a plane, the third distance D3f need not be equal to one-fourth of the circumferential length of the sectional circle of the shaft 21f. For example, in the state that the sensor unit 10f is expanded in a plane, in a case that the third distance D3f is equal to one-sixth of the circumferential length of the sectional circle of the shaft 21f, the first center point CP1f of the first sensor portion 12f and the third center point CP3f of the third sensor portion 14f are disposed to be separated from each other by 60 degrees in the circumferential direction DIRC of the shaft 21f in the state that the sensor unit 10f is attached to the shaft 21f.

In the state that the sensor unit 10f is expanded in a plane, the fourth distance D4f need not be equal to three-fourths of the circumferential length of the sectional circle of the shaft 21f. For example, in the state that the sensor unit 10f is expanded in a plane, in a case that the fourth distance D4f is equal to one-sixth of the circumferential length of the sectional circle of the shaft 21f, the first center point CP1f of the first sensor portion 12f and the fourth center point CP4f of the fourth sensor portion 15f are disposed to be separated from each other by 60 degrees in the circumferential direction DIRC of the shaft 21f in the state that the sensor unit 10f is attached to the shaft 21f.

In the state that the sensor unit 10f is expanded in a plane, the fifth distance D5f need not be equal to one-fourth of the circumferential length of the sectional circle of the shaft 21f. For example, in the state that the sensor unit 10f is expanded in a plane, in a case that the fifth distance D5f is equal to one-sixth of the circumferential length of the sectional circle of the shaft 21f, the second center point CP2f of the second sensor portion 13f and the third center point CP3f of the third sensor portion 14f are disposed to be separated from each other by 60 degrees in the circumferential direction DIRC of the shaft 21f in the state that the sensor unit 10f is attached to the shaft 21f.

In the state that the sensor unit 10f is expanded in a plane, the sixth distance D6f need not be equal to one-fourth of the circumferential length of the sectional circle of the shaft 21f. For example, in the state that the sensor unit 10f is expanded in a plane, in a case that the sixth distance D6f is equal to one-sixth of the circumferential length of the sectional circle of the shaft 21f, the second center point CP2f of the second sensor portion 13f and the fourth center point CP4f of the fourth sensor portion 15f are disposed to be separated from each other by 60 degrees in the circumferential direction DIRC of the shaft 21f in the state that the sensor unit 10f is attached to the shaft 21f.

The third sensor portion 14f and the fourth sensor portion 15f may be disposed between the shaft 21f and the first sensor portion 12f, and between the shaft 21f and the second sensor portion 13f.

In the state that the sensor unit 10f is expanded in a plane, positions in the up-down direction of the first center point CP1f of the first sensor portion 12f, the second center point CP2f of the second sensor portion 13f, the third center point CP3f of the third sensor portion 14f, and the fourth center point CP4f of the fourth sensor portion 15f may be different from each other.

In the state that the sensor unit 10f is expanded in a plane, the first sensor portion 12f, the second sensor portion 13f, the third sensor portion 14f, and the fourth sensor portion 15f may be arranged side by side in the up-down direction.

In the state that the sensor unit 10f is expanded in a plane, the back main surface of the third sensor portion 14f may have a portion not overlapping the back main surface of the fourth sensor portion 15f in a view in the front-back direction.

In the state that the sensor unit 10f is expanded in a plane, the front main surface of the first sensor portion 12f or the front main surface of the second sensor portion 13f may have a portion not overlapping the front main surface of the third sensor portion 14f or the front main surface of the fourth sensor portion 15f in a view in the front-back direction.

Part of an outer edge of the front main surface of the third sensor portion 14f and part of an outer edge of the front main surface of the fourth sensor portion 15f may be in contact with each other via an adhesive layer having an insulation property.

Part of an outer edge of the back main surface of the third sensor portion 14f and part of an outer edge of the back main surface of the fourth sensor portion 15f may be in contact with each other. Part of the outer edge of the back main surface of the third sensor portion 14f and part of the outer edge of the back main surface of the fourth sensor portion 15f may be in contact with each other via an adhesive layer having an insulation property.

It is acceptable that the fourth sensor portion 15f is not provided.

### Other Embodiments

The sensor unit according to the present disclosure is not limited to the sensor unit 10 and 10a to 10f, and can be changed within the scope of the gist thereof. Further, any combination of the configurations of the sensor unit 10 and 10a to 10f is acceptable.
10, 10a, 10b, 10c, 10d, 10e, 10f SENSOR UNIT
11, 11a, 11b, 11c, 11d, 11e SHEET
12, 12a, 12b, 12c, 12d, 12e, 12f FIRST SENSOR PORTION
13, 13a, 13b, 13c, 13d, 13e, 13f SECOND SENSOR PORTION
14f THIRD SENSOR PORTION
15f FOURTH SENSOR PORTION
20, 20a, 20b, 20c, 20d, 20e, 20f GOLF CLUB
21, 21a, 21b, 21c, 21d, 21e, 21f SHAFT
22 HEAD
123, 133, 143, 153 PIEZOELECTRIC FILM
124a, 134a, 144a, 154a FIRST ELECTRODE
124b, 134b, 144b, 154b SECOND ELECTRODE
125, 135, 145, 155 CHARGE AMPLIFIER
126, 136, 146, 156 VOLTAGE AMPLIFICATION CIRCUIT
OD1, OD2, OD3, OD4 UNIAXIAL EXTENSION AXIS
S121, S131, S141, S151 FRONT MAIN SURFACE
S122, S132, S142, S152 BACK MAIN SURFACE
CP1, CP1b, CP1c, CP1f FIRST CENTER POINT
CP2, CP2b, CP2c, CP2f SECOND CENTER POINT
CP3f THIRD CENTER POINT
CP4f FOURTH CENTER POINT
D1, D1c, D1f FIRST DISTANCE
D2f SECOND DISTANCE
D3f THIRD DISTANCE
D4f FOURTH DISTANCE
D5f FIFTH DISTANCE
D6f SIXTH DISTANCE

1. A sensor unit for detecting deformation of an object to be measured, the sensor unit comprising:
a first sensor portion configured to detect deformation of the object and having a film shape;
a second sensor portion configured to detect deformation of the object and having a film shape; and
a sheet attached to the object,
wherein a main surface of the first sensor portion and a main surface of the second sensor portion are attached to the sheet, and
wherein the main surfaces of the first sensor portion and the second sensor portion don not fully overlap each other in a planar plan view of the sheet along a direction normal to the main surface of the sheet, such that the main surface of the first sensor portion has a nonoverlapping region that does not overlap the main surface of the second sensor portion, and the main surface of the second sensor portion has a nonoverlapping region that does not overlap the main surface of the first sensor portion.

2. The sensor unit according to claim 1, wherein the first sensor portion and the second sensor portion are disposed between the object when the sensor unit is attached to the object.

3. The sensor unit according to claim 1, wherein the sheet is disposed between the object and the first sensor portion and between the object and the second sensor portion when the sensor unit is attached to the object.

4. The sensor unit according to claim 1, wherein a shape of the object extends in a first direction,
wherein a rotating direction around the first direction is a circumferential direction, and
wherein a length of the main surface of the sheet in the circumferential direction is shorter than a length of the object in the circumferential direction.

5. The sensor unit according to claim 4, wherein the main surface of the first sensor portion has a second nonoverlapping region that does not overlap the main surface of the sheet in the planar plan view of the sheet.

6. The sensor unit according to claim 4, wherein the main surface of the second sensor portion has a second nonoverlapping region that does not overlap the main surface of the sheet in the planar plan view of the sheet.

7. The sensor unit according to claim 1, wherein the sheet is an insulator.

8. The sensor unit according to claim 1, wherein part of an outer edge of the main surface of the first sensor portion and part of an outer edge of the main surface of the second sensor portion are in contact with each other.

9. The sensor unit according to claim 1,
wherein the main surface of the first sensor portion has an overlapping region that overlaps the main surface of the second sensor portion in the planar plan view, and
wherein the main surface of the second sensor portion has an overlapping region that overlaps the main surface of the first sensor portion in the planar plan view.

10. The sensor unit according to claim 1, wherein a distance between a first center point of the first sensor portion and a second center point of the second sensor portion is one-fourth or three-fourths of a length of the object in a circumferential direction in the planar plan view, the circumferential direction being a rotating direction around an extension direction of the object.

11. The sensor unit according to claim 1,
wherein the first sensor portion comprises a first piezoelectric body,
wherein the first piezoelectric body is a film comprising polylactic acid and extends in at least one axial direction,
wherein a main surface of the first piezoelectric body has a rectangular shape in the planar plan view of the sheet,
wherein the second sensor portion comprises a second piezoelectric body,
wherein the second piezoelectric body is a film comprising polylactic acid and extends in at least one axial direction, and
wherein a main surface of the second piezoelectric body has a rectangular shape in the planar plan view.

12. The sensor unit according to claim 11, wherein an extension axis of the first piezoelectric body forms an angle of 0 degrees, 180 degrees, 45 degrees, −45 degrees, 90 degrees, or −90 degrees relative to a longitudinal direction of the first piezoelectric body in the planar plan view.

13. The sensor unit according to claim 11, wherein an extension axis of the second piezoelectric body forms an angle of 0 degrees, 180 degrees, 45 degrees, −45 degrees, 90 degrees, or −90 degrees relative to a longitudinal direction of the second piezoelectric body in the planar plan view.

14. The sensor unit according to claim 1, wherein the sheet is a third sensor portion configured to detect deformation of the object and has a film shape.

15. The sensor unit according to claim 14, further comprising:
a fourth sensor portion configured to detect deformation of the object and having a film shape,
wherein a main surface of the third sensor portion has a nonoverlapping region that does not overlap a main surface of the fourth sensor portion, and an overlapping region that overlaps the main surface of the first sensor portion or the main surface of the second sensor portion in the planar plan view,
wherein the main surface of the fourth sensor portion has a nonoverlapping region that does not overlap the main surface of the third sensor portion and an overlapping region that overlaps the main surface of the first sensor portion or the main surface of the second sensor portion in the planar plan view,
wherein part of an outer edge of the main surface of the third sensor portion and part of an outer edge of the main surface of the fourth sensor portion are in contact with each other,
wherein in the planar plan view a distance between a first center point of the first sensor portion and a second center point of the second sensor portion is one-half of a length of the object measured in a circumferential direction, the circumferential direction being a rotating direction around an extension direction of the object,
wherein in the planar plan view a distance between a third center point of the third sensor portion and a fourth center point of the fourth sensor portion is one-half of the length of the object in the circumferential direction, and
wherein in the planar plan view a distance between the first center point of the first sensor portion or the second center point of the second sensor portion and the third center point of the third sensor portion or the fourth center point of the fourth sensor portion is one-fourth or three-fourths of the length of the object in the circumferential direction.

16. The sensor unit according to claim 14,
wherein the third sensor portion comprises a third piezoelectric body,
wherein the third piezoelectric body is a film comprising polylactic acid and extends in at least one axial direction, and
wherein a main surface of the third piezoelectric body has a rectangular shape in the planar plan view.

17. The sensor unit according to claim 15,
wherein the fourth sensor portion comprises a fourth piezoelectric body,
the fourth piezoelectric body is a film comprising polylactic acid and extends in at least one axial direction, and
wherein a main surface of the fourth piezoelectric body has a rectangular shape in the planar plan view.

18. The sensor unit according to claim 17, an extension axis of a third piezoelectric body forms an angle of 45 degrees counterclockwise relative to a longitudinal direction of the third piezoelectric body in the planar plan view, and
wherein an extension axis of the fourth piezoelectric body forms an angle of −45 degrees counterclockwise relative to a longitudinal direction of the fourth piezoelectric body in the planar plan view.

19. The sensor unit according to claim 1,
wherein the main surface of the first sensor portion does not overlap the main surface of the second sensor portion in the planar plan view, and
wherein the main surface of the second sensor portion does not overlap the main surface of the first sensor portion in the planar plan view.

20. The sensor unit according to claim 1, wherein a long side or a long axis of the main surface of the first sensor portion is parallel to a long side or a long axis of the main surface of the second sensor portion in the planar plan view.
